(19) United States
(12) Patent Application Publication
(10) Pub. No.: US 2025/0361425 A1
(43) Pub. Date: Nov. 27, 2025

(54) BRITTLE ADHESIVE SHEET AND BRITTLE ADHESIVE SHEET PRODUCTION METHOD

(71) Applicant: LINTEC CORPORATION, Tokyo (JP)

(72) Inventors: Chiaki FUKUI, Tokyo (JP); Tadahiro TOMINO, Tokyo (JP)

(21) Appl. No.: 19/298,334

(22) Filed: Aug. 13, 2025

Related U.S. Application Data
(62) Division of application No. 17/251,487, filed on Dec. 11, 2020.

(30) Foreign Application Priority Data
Sep. 25, 2018 (JP) 2018-178876

(51) Int. Cl. C09J 7/29; B32B 7/12; B32B 27/08; B32B 27/30; B32B 27/36; B32B 37/26

(52) U.S. Cl. CPC C09J 7/29; B32B 7/12; B32B 27/08; B32B 27/302; B32B 27/308; B32B 27/36; B32B 37/26; B32B 2037/268; B32B 2250/24; B32B 2307/412; B32B 2307/516; B32B 2307/54; B32B 2307/5825; B32B 2307/75; B32B 2405/00; C09J 2203/338; C09J 2301/162; C09J 2425/006; C09J 2433/006; C09J 2467/006

(57) ABSTRACT

A brittle adhesive sheet includes a film base material, and an adhesive layer provided at a first surface side of the film base material, wherein the film base material has a film base material main body formed of a polystyrene-based resin and a print receptive layer provided at a second surface side, opposite to a side of the film base material where the adhesive layer is provided, and the print receptive layer includes a polyester-based resin or an acrylic-based resin.

### CROSS REFERENCE TO RELATED APPLICATIONS

This application is a divisional of U.S. application Ser. No. 17/251,487, filed Dec. 11, 2020, which is the U.S. national phase of International Application No. PCT/JP2019/036761 filed Sep. 19, 2019 which designated the U.S. and claims priority to JP Patent Application No. 2018-178876 filed Sep. 25, 2018, the entire contents of each of which are hereby incorporated by reference.

### TECHNICAL FIELD

The present invention relates to a brittle adhesive sheet, a brittle adhesive label, and a method for producing the brittle adhesive sheet.

### BACKGROUND ART

In recent years, as automobile parts, electrical and electronic parts, precision machine parts, and the like have become smaller, higher in density, and higher in performance, under product liability laws, there are demands in terms of legal regulations to label the features and handling precautions for each part or product in order to ensure safety in product use. In such cases, it is necessary to prevent the labeled contents from being tampered with and tampering prevention labels or the like are used accordingly.

On the other hand, adhesive labels for sealing are often used for purposes such as certifying and sealing products or the like. However, illegal acts, in which the sealing label is temporarily peeled off, the contents are modified or the contents are replaced, and then sealing is carried out again with the same label, occur frequently and this is a problem. For this reason, labels for preventing unauthorized unsealing are used in order to prevent the improper reattachment and reuse of labels.

In addition, in a case of consigning or packing articles, in order to prevent improper unsealing of the articles or opening of lids, the openings are usually sealed with tampering prevention tape or the like in a case where such prevention is not possible with a lock or the like. For example, in a case of transporting a desk, a cabinet, a safety box such as a safe, baggage, or the like, a tape or seal for preventing unauthorized unsealing is generally attached to the outside of the drawer, door, lid, or the like.

As a security member such as a label, a tape, a seal, or the like for preventing tampering or unauthorized unsealing, for example, a type is known in which the base material is broken when the member is peeled from the adherend, a type in which peeling marks remain on the adherend, and the like.

In addition, there is a demand for tampering prevention labels or the like that can be printed on a surface in order to improve distinguishability, prevent label replacement, and the like.

### CITATION LIST

### Patent Literature

### [Patent Literature 1]

Japanese Unexamined Patent Application, First Publication No. H10-105063

### SUMMARY OF INVENTION

### Technical Problem

Here, it is possible to produce such a tampering prevention label or the like, for example, by subjecting an adhesive sheet provided with an adhesive layer on a film base material to a printing process and die cutting the sheet into a predetermined shape. As an adhesive sheet that can be used for the label as described above, adhesive sheets using a polystyrene-based resin as the film base material are being studied (refer to, for example, Patent Literature 1). However, in cases of producing a tampering prevention label or the like of a type in which the base material is broken, there were the following problems during the production of the label. In order to obtain a die cut label in a predetermined shape from the adhesive sheet, generally, an operation is performed in which a cut is made in a predetermined shape on the adhesive sheet and surrounding unnecessary portions (matrix waste) not used as the label of the adhesive sheet are peeled and removed from the release liner (matrix removal). At this time, in a tampering prevention label of the related art, since the film base material is easily torn, the matrix waste is easily broken. Therefore, every time the matrix waste was broken, the matrix removal was interrupted and it was not possible to efficiently produce the label.

The present invention was made to solve the problems described above and has an object of providing a brittle adhesive sheet and a method for producing the brittle adhesive sheet excellent in printability in which a tampering or unauthorized unsealing prevention effect and suppression of matrix waste breaking are both satisfied.

### Solution to Problem

As a result of intensive studies to solve the problems described above, the present inventors found that providing a film base material with a film base material main body formed of a polystyrene-based resin and a print receptive layer makes it possible to obtain a brittle adhesive sheet excellent in printability in which a tampering or unauthorized unsealing prevention effect and suppression of matrix waste breaking are both satisfied, thereby completing the present invention.

That is, one aspect of the present invention is a brittle adhesive sheet and a method for producing the brittle adhesive sheet shown below.

(1) A brittle adhesive sheet, comprising a film base material, and an adhesive layer provided at a first surface side of the film base material, wherein the film base material has a film base material main body formed of a polystyrene-based resin and a print receptive layer provided at a second surface side of the film base material, opposite to a side where the adhesive layer is provided, and the print receptive layer includes a polyester-based resin or an acrylic-based resin.

(2) The brittle adhesive sheet according to (1), wherein the brittle adhesive sheet is transparent.

(3) The brittle adhesive sheet according to (1) or (2), wherein a total light transmittance measured according to JIS K 7361-1:1997 is 80% or more, and/or a haze measured according to JIS K 7136:2000 is 50% or less.

(4) The brittle adhesive sheet according to any one of (1) to (3), wherein the film base material has a tensile elongation at break of 20% or less, the tensile elongation measured in a machine direction (MD) according to JIS Z 0237:2009.

(5) The brittle adhesive sheet according to any one of (1) to (4), wherein the film base material has a tensile strength at break of 100 N/15 mm or less, the tensile strength at break measured in the machine direction (MD) according to JIS Z 0237:2009.

(6) The brittle adhesive sheet according to any one of (1) to (5), wherein the film base material has a tear strength of 1500 mN/mm or less, the tear strength measured in the machine direction (MD) according to JIS K 7128-1:1998.

(7) The brittle adhesive sheet according to any one of (1) to (6), wherein, when a tear strength test is performed in the machine direction (MD) and a cross machine direction (CD) at 90° with respect to the machine direction, the film base material has a tear strength ratio (MD tear strength/CD tear strength) of 0.7 or less.

(8) The brittle adhesive sheet according to any one of (1) to (7), wherein the film base material has a tear strength of 1000 mN/mm or more and 5000 mN/mm or less, the tear strength measured in the cross machine direction (CD) at 90° with respect to the machine direction according to JIS K 7128-1:1998.

(9) The brittle adhesive sheet according to any one of (1) to (8), wherein the film base material main body is a uniaxially stretched film.

(10) The brittle adhesive sheet according to any one of (1) to (9), wherein the polystyrene-based resin of the film base material main body includes a GPPS resin and a HIPS resin.

(11) The brittle adhesive sheet according to any one of (1) to (10), wherein a content of a thermoplastic elastomer is 10 parts by mass or less with respect to 100 parts by mass of the polystyrene-based resin of the film base material main body.

(12) The brittle adhesive sheet according to any one of (1) to (11), wherein the print receptive layer includes an acrylic-based resin.

(13) The brittle adhesive sheet according to any one of (1) to (12), wherein the brittle adhesive sheet is used for preventing unauthorized unsealing or preventing tampering.

(14) A method for producing the brittle adhesive sheet according to any one of (1) to (13), the method comprising a base material main body-forming step of forming a film base material main body formed of a polystyrene-based resin; an adhesive layer-forming step of forming an adhesive layer at a first surface side of the film base material main body; and a print receptive layer-forming step of forming a print receptive layer including a polyester-based resin or an acrylic-based resin at a second surface side of the film base material main body.

(15) The method for producing the brittle adhesive sheet according to (14), wherein the base material main body-forming step is a step of forming a film base material main body formed of a polystyrene-based resin by uniaxial stretching.

### Advantageous Effects of Invention

According to the present invention, it is possible to provide a brittle adhesive sheet and a method for producing the brittle adhesive sheet excellent in printability in which a tampering or unauthorized unsealing prevention effect and suppression of matrix waste breaking are both satisfied.

### BRIEF DESCRIPTION OF DRAWINGS

FIG. 1 is a cross-sectional view showing a configuration of a brittle adhesive sheet according to an embodiment.

FIG. 2 is a plan view showing an example of brittle adhesive labels of an embodiment.

FIG. 3 is a plan view showing a test piece used for a tear strength test.

FIG. 4 is a perspective view showing an outline of a tear strength test.

FIG. 5 is a plan view showing a pattern used for the evaluation of a matrix waste breaking property.

### DESCRIPTION OF EMBODIMENTS

A description will be given below of embodiments of a brittle adhesive sheet, a method for producing the brittle adhesive sheet, and a brittle adhesive label (may be referred to below simply as a “label”). The wording “brittleness” itself described above is not essential and therefore it is possible to rephrase the brittle adhesive sheet, the brittle adhesive label, and the method for producing the brittle adhesive sheet described above as an adhesive sheet, an adhesive label, and a method for producing an adhesive sheet, respectively.

### <<Brittle Adhesive Sheet>>

The brittle adhesive sheet of the embodiment is provided with a film base material, and an adhesive layer provided at a first surface side of the film base material, in which the film base material is provided with a film base material main body formed of a polystyrene-based resin and a print receptive layer provided at a second surface side of the film base material opposite to the side where the adhesive layer is provided, and the print receptive layer includes a polyester-based resin or an acrylic-based resin.

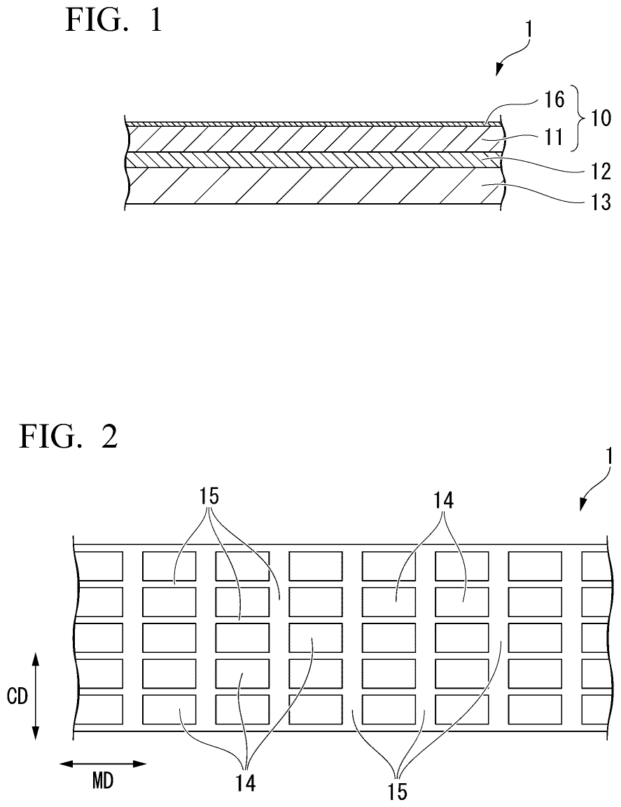

FIG. 1 is a cross-sectional view showing the configuration of a brittle adhesive sheet of an embodiment. A brittle adhesive sheet 1 of the embodiment is provided with a film base material 10 and an adhesive layer 12 provided on a first surface side of the film base material 10. The film base material 10 is provided with a film base material main body 11 and a print receptive layer 16 provided on a second surface side opposite to the side where the adhesive layer 12 is provided. In addition, the brittle adhesive sheet 1 is also provided with a release liner 13 provided on the surface of the adhesive layer 12 opposite to the side where the film base material 10 is provided.

The film base material main body 11 is formed of a polystyrene-based resin. Polystyrene-based resin is a material which is comparatively brittle and easy to tear. Therefore, after the brittle adhesive sheet 1 using a polystyrene-based resin for the film base material main body 11 is stuck to an adherend, the brittle adhesive sheet 1 is broken when peeled from the adherend and evidence remains that the brittle adhesive sheet 1 was peeled from the adherend. In addition, breaking the brittle adhesive sheet makes it impossible to hide the fact that the brittle adhesive sheet was peeled by reattaching and reusing the brittle adhesive sheet. Accordingly, since the film base material main body 11 is formed of a polystyrene-based resin, the brittle adhesive sheet 1 exhibits an excellent tampering or unauthorized unsealing prevention effect.

In addition, as shown in FIG. 2, the brittle adhesive label of the embodiment is, for example, a label which is printed on a brittle adhesive sheet, die cut, and subjected to matrix removal.

It is possible to use the brittle adhesive sheet 1 to produce a label. It is possible to obtain the label, for example, by subjecting the print receptive layer 16 of the brittle adhesive sheet to a printing process and die cutting the film base material 10 and the adhesive layer 12 into a predetermined shape. Here, the brittle adhesive sheet 1 may be for forming a label of any shape and, in the present embodiment, description will be given of the brittle adhesive sheet 1 having label portions 14 in a plurality of substantially rectangular shapes arranged in the form of islands and a matrix waste portion 15 which is a portion other than the label portions 14. It is possible to form only the label portions 14 on the release liner 13 through an operation of peeling and removing the matrix waste portion 15 of the brittle adhesive sheet 1 from the release liner 13 as matrix waste (unnecessary portions).

However, with the adhesive sheets for labels of the related art which use a polystyrene-based resin as the film base material, it was difficult to produce labels efficiently. That is, since the polystyrene-based resin is comparatively brittle and easy to tear, in the step of removing the matrix waste portion of the adhesive sheets for a label as matrix waste (matrix removal), a phenomenon in which thin matrix waste is broken(matrix waste breaking) frequently occurs.

In such a case, a matrix waste portion which should originally be removed remains on the release liner and it is necessary to perform the matrix removal operation again individually. In particular, in a case where matrix waste is continuously removed from the release liner while the matrix waste is wound by a roller, it is necessary to carry out an operation of winding the matrix waste again on the roller, resulting in poor productivity. In addition, in particular, in a case where the area of the matrix waste portion is reduced in order to increase the area of the label portion from the viewpoint of resource saving and productivity, the matrix waste tends to be thin and the problem (matrix waste breaking) described above occurs to a remarkable extent.

On the other hand, in the brittle adhesive sheet 1 of the embodiment, the film base material 10 is provided with the print receptive layer 16. With such a configuration, it is possible to improve the film strength to a very suitable state, in which matrix waste breaking is suppressed while having an excellent tampering or unauthorized unsealing prevention effect due to the excellent brittleness, and to satisfy both the tampering or unauthorized unsealing prevention effect and the suppression of matrix waste breaking. In addition, excellent printability is also exhibited at the same time.

A detailed description will be given below of each of the layers forming the brittle adhesive sheet 1.

### <Film Base Material>

The film base material 10 has a function of imparting physical strength such as rigidity and flexibility to the brittle adhesive sheet 1. On the other hand, the film base material main body 11 is easily broken (brittle) due to being formed of the polystyrene-based resin. Since the film base material main body 11 is brittle, the brittle adhesive sheet 1 is brittle as a whole. The term “brittle” as used herein means that the film base material 10 and the adhesive layer 12 of the brittle adhesive sheet may be broken and fragmented. Since the strength of the brittle adhesive sheet 1 is mainly imparted by the film base material 10, in order for the brittle adhesive sheet to be fragmented, it is considered important that the film base material 10 be easy to tear and have a property of being easily broken.

As values indicating properties relating to the brittleness and the matrix waste breaking property of the film base material 10, it is possible to adopt evaluation items relating to the items of the tensile elongation at break, tensile strength at break, and tear strength, as shown below.

The machine direction of the film base material 10 described below (also referred to below as machine direction: MD) matches the machine direction at the time of film-forming the film base material main body 11, and also matches the longitudinal direction of the film. The cross machine direction (also referred to below as cross machine direction: CD) at 90° with respect to the machine direction of the film base material is the direction at 90° with respect to the machine direction when forming the film base material and also matches the width direction of the film.

It is possible for a person skilled in the art to easily determine the machine direction of the film base material main body 11 by confirming the film properties.

The film base material 10 preferably has a tensile elongation at break in the machine direction (MD) measured according to JIS Z 0237:2009 of 20% or less, more preferably 1% or more and 10% or less, and even more preferably 3% or more and 7% or less. When the tensile elongation at break of the film base material in the machine direction is in the range described above, the produced label has good brittleness. That is, when a force is applied to the film base material in order to peel the label, the film base material is not easily stretched and, due to this, the film is easily broken. In addition, in particular, when the tensile elongation at break in the machine direction of the film base material is 3% or more, it is possible to even more suitably suppress matrix waste breaking.

The film base material 10 preferably has a tensile strength at break in the machine direction measured according to JIS Z 0237:2009 of 100 N/15 mm or less, more preferably 15 N/I5 mm or more and 50 N/I5 mm or less, and even more preferably 28 N/15 mm or more and 35 N/15 mm or less. When the tensile strength at break in the machine direction of the film base material is the upper limit value or less, the brittleness of the produced label becomes good.

That is, when a force is applied to the film base material to peel the label from the adherend, the film base material breaks easily. In addition, in particular, when the tensile strength at break in the machine direction of the film base material is 28 N/15 mm or more, it is possible to even more suitably suppress matrix waste breaking.

Here, JIS Z 0237:2009 is based on ISO 29864:2007 “Self-adhesive tapes-Measurement of breaking strength and elongation at break” and is a Japanese Industrial Standard created by translating the corresponding parts thereof without changing the technical content, and test items which are not specified in the corresponding international standards (thickness measurement, width measurement, length measurement, tear strength, low-speed and high-speed unwinding force, inclined ball tack, and water vapor permeability) are added as Japan industry standards.

A detailed description will be given of the tensile elongation at break and tensile strength at break measured according to JIS Z 0237:2009 described above. [Tensile strength (tensile strength at break) and elongation (tensile elongation at break)]

### <Test Piece>

When collecting test pieces, a sheet is cut out at a width of 15 mm. Five or more flat test pieces are collected and the length of the test pieces is set to approximately 140 mm. The thickness of the test piece may be the thickness of the film base material of the target product.

### <Test Apparatus>

For the tensile tester, the tensile tester specified in JIS B 7721 (ISO 7500-1:2004) (tester grade 1: relative indication error±1.0%) or a tensile tester equivalent thereto is used.

A tester with a capacity for which the measured values are in the range of 15 to 85% of the capacity is used. The pulling speed is 5 ±0.2 mm/s and the reading tolerance is 2% or less. As a method for displaying the measured values, any of an analog type, a digital type, a digital recording type, and a chart recording type may be used.

### <Test Method>

The test method measures the load and elongation when a test piece is broken by pulling at a speed of 200 mm/min, with the gripping distance of chucks of the tensile tester or marked lines interval of the test piece being 100 mm. In such a case, the test pieces which break within 5 mm from the chuck edge are discarded and the measurement is continued until the number of correctly broken test pieces is finally five.

The tensile strength and elongation are calculated by the following equations.

$$T = \frac{15 \times P}{W}$$

T: Tensile strength (N/15 mm)

P: Maximum load until breaking (N)

W: Width of test piece (mm)

$$E = \frac{{L}_{1} - {L}_{0}}{{L}_{0}} \times 100$$

E: Elongation (%)

L0: Initial distance between the chucks or the marked lines (mm)

L1: Distance between the chucks or the marked lines (mm) when breaking

The values of the tensile test described above are measured in the machine direction and thus reflect a situation when the label is peeled along the machine direction. However, even in a case of peeling the label along a direction other than the machine direction, the label peeling operation is usually performed starting from a part of the periphery of the label, thus, a constant force is applied in the machine direction and the tensile test value reflects the brittleness of the brittle adhesive label itself.

The film base material 10 preferably has a tear strength measured according to JIS K 7128-1:1998 Trouser Tear Method in the cross machine direction (CD) at 90° with respect to the machine direction of 1000 mN/mm or more, more preferably 1500 mN/mm or more and 5000 mN/mm or less, and even more preferably 1800 mN/mm or more and 3000 mN/mm or less. When the value of the tear strength with respect to the CD described above is the lower limit value described above or more, matrix waste breaking is suitably suppressed. When the value of the tear strength with respect to the CD described above is the upper limit value described above or less, the brittleness becomes good.

The film base material 10 preferably has a tear strength in the machine direction (MD) measured according to JIS K 7128-1:1998 Trouser Tear Method of 1500 mN/mm or less, more preferably 100 mN/mm or more and 1000 mN or less, and even more preferably 300 mN/mm or more and 800 mN/mm or less. When the value of the tear strength with respect to the MD is the upper limit value described above or less, the brittleness becomes good. When the value of the tear strength with respect to the MD is the lower limit value described above or more, matrix waste breaking is suitably suppressed.

JIS K 7128-1:1998 is based on ISO 6383-1:1983 “Film and sheeting-Determination of tear resistance-Part 1: Trouser tear method” and is a Japanese Industrial Standard created by translating the corresponding parts thereof without changing the technical content, but the contents of the original international standard are partially changed. A detailed description will be given of the tear test described above measured according to JIS K 7128-1:1998 Trouser Tear Method.

The following is a case of performing the tear test in the cross machine direction (CD) at 90° with respect to the machine direction.

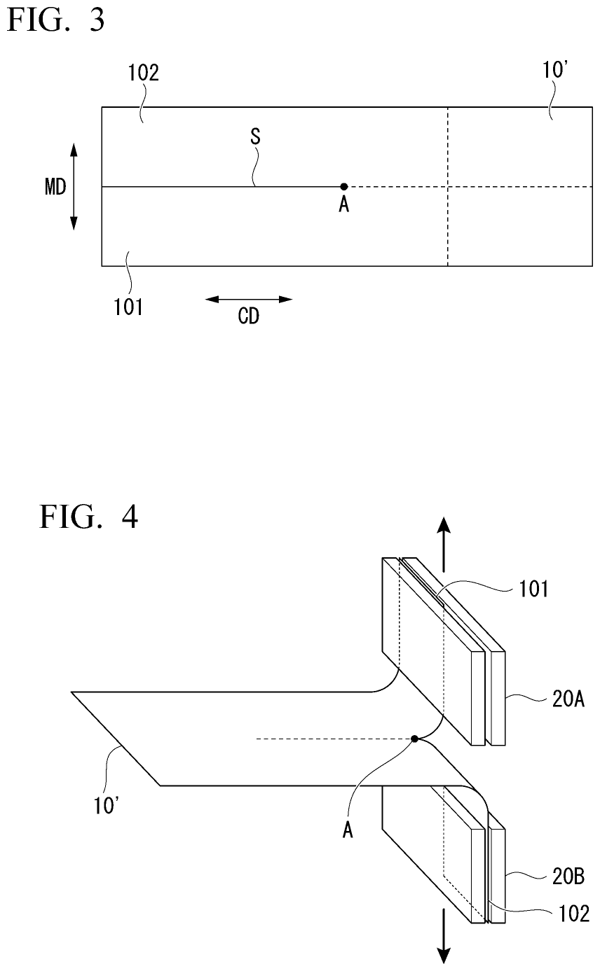

In FIG. 3, a test piece 10′ is a part of the film base material 10. The test piece 10′ is cut out such that the long side direction of the test piece 10′ is the width direction (CD) of the film base material 10 and the short side direction of the test piece 10′ is the longitudinal direction (MD) of the film base material 10. In addition, the test piece 10′ is provided with a slit S along the CD at the central portion of the MD. In addition, a tear strength test is performed using the test piece 10′.

In addition, in FIG. 4, an end 101 and an end 102 of the test piece 10′ are fixed by being gripped by a gripping tool 20A and a gripping tool 20B, respectively. A tear strength test is performed by moving the gripping tool 20A and the gripping tool 20B at a speed of 300 mm/min in the separating direction (the direction of the arrows in the drawing). The tear strength is obtained as a value obtained by dividing the obtained tear force (mN) by the thickness (mm) of the test piece. The thickness of the test piece may be the thickness of the film base material of the target product.

Here, in a case of performing a tear test with respect to the MD, the CD and MD of the test piece described above are reversed.

The adhesive strength exhibited by the adhesive layer 12 of the embodiment on the adherend is large, but is small on the release liner 13 which is to be peeled. Accordingly, the force applied to the film base material when peeling the label from the adherend is comparatively large, and the values of the tensile properties and the tearing physical properties described above are small enough to exhibit brittleness when the label is peeled from the adherend. On the other hand, the force for tearing and removing the matrix waste portion of the adhesive sheet from the release liner at the time of matrix removal is small enough to allow the laminate of the matrix waste portion and the release liner to be peeled, thus, the force applied to the film base material is comparatively small and the values of the tensile properties and tearing physical properties described above are large enough that the occurrence of matrix waste breaking during matrix removal is suitably suppressed.

When the tear strength test is performed on the film base material 10 in the machine direction (MD) and the cross machine direction (CD) at 90° with respect to the machine direction, the tear strength ratio (tear strength of MD/tear strength of CD) is preferably less than 1, preferably 0.7 or less, more preferably 0.5 or less, and even more preferably 0.1 or more and 0.4 or less. When the strength ratio is in the range described above, there is a tendency to more easily satisfy both brittleness and matrix waste breaking suppression.

In the tear strength described above, it is considered that if the tear strength ratio (tear strength of MD/tear strength of CD) is less than 1, at least the tear strength value in MD is small and, due to this, tearing in MD easily occurs, the tensile properties of the torn fragments are deteriorated, and the brittleness of the film base material is easily exhibited.

In addition, from the viewpoint of increasing the efficiency of matrix removal, it is preferable to perform matrix removal along the MD. In that case, when a break occurs in the CD, the matrix waste portion is broken and the matrix waste portion remains on the release liner in many cases. However, it is considered that at least the value of the tear strength of the CD is large and, due to this, the matrix waste portion is prevented from being torn in the CD at the time of matrix removal and matrix waste breaking is easily suppressed.

In this manner, the method for producing a film base material, in which the tearing physical properties differ between MD and CD and, in particular, the tear strength ratio (MD tear strength/CD tear strength) is less than 1 (that is, CD tear strength>MD tear strength), is not particularly limited, but the film base material main body 11 is preferably a uniaxially stretched film stretched in the MD direction. When matrix removal is performed in the MD direction, the film base material main body is likely to tear in the CD direction. The film base material main body 11 stretched only in the MD direction does not have a high tear strength in the MD direction, but tends to have a high tear strength in the CD direction. Due to this, it is possible to obtain a brittle adhesive sheet in which, at the time of matrix removal, tearing is difficult in the CD direction (matrix waste breaking is prevented) and, when peeling from an adherend, tearing is easy in the MD direction (preventing re-sticking or the like).

Examples of the uniaxial stretching method include the T-die method, and the uniaxially stretched film described above is preferably a T-die molding film.

A uniaxially stretched film formed of a polystyrene-based resin is considered to be in a state in which the polystyrene is oriented in the stretching direction. That is, it is considered that tearing is likely to occur along the polystyrene orientation direction (corresponding to MD) and tearing is not likely to occur with respect to the direction (corresponding to CD) at 90° with respect to the polystyrene orientation direction.

The film base material main body 11 is formed of a polystyrene-based resin. That is, the film base material main body 11 includes a polystyrene-based resin.

Polystyrene-based resins that can be used for the film base material main body 11 are not particularly limited; however, examples thereof include a polystyrene resin which is a polymer of only styrene (GPPS resin, GPPS: General Purpose Polysthylene), a polystyrene resin including a rubber component obtained by graft-polymerizing styrene with a rubber component (HIPS resin, HIPS: High-Impact Polysthylene), a polystyrene resin in which a GPPS resin and an HIPS resin are blended (MIPS resin), a styrene-acrylonitrile copolymer (AS resin), a styrene-methyl methacrylate copolymer resin, a styrene-butadiene-acrylonitrile copolymer resin (ABS resin), a modified polyphenylene ether resin (modified PPE resin) obtained by alloying a GPPS resin with polyphenylene ether, and the like.

In the above, since the rubber component-containing polystyrene resin has elasticity and flexibility to a certain extent, there is an advantage in that the tensile elongation at break described above is easily adjusted to a suitable range. It is considered that this is because, in the rubber component-containing polystyrene resin, the particulate rubber component is finely dispersed in the polystyrene and the particulate rubber component contributes to the improvement of the elasticity and flexibility of the film base material main body 11. In particular, in a case where an HIPS resin is used as the polystyrene-based resin among the rubber component-containing polystyrene resins, this effect becomes remarkable.

In a case where the HIPS resin is included as a polystyrene-based resin, the content of the HIPS resin with respect to the total mass of the polystyrene-based resin may be 50 to 100% by mass, 65 to 95% by mass, or 75 to 90% by mass. Due to this, it is possible to make the flexibility and elasticity particularly excellent while the brittleness of the film base material main body 11 is sufficient. As a result, in the brittle adhesive sheet 1, matrix waste breaking is particularly suppressed.

In a case where a GPPS resin is included as the polystyrene-based resin, the content of the GPPS resin with respect to the total mass of the polystyrene-based resin may be 5 to 35% by mass, or 10 to 25% by mass. Including the GPPS resin in the film base material main body appropriately improves the brittleness of the brittle adhesive sheet 1.

In addition, including a polystyrene resin (MIPS resin) in which a GPPS resin and an HIPS resin are blended in the film base material main body satisfies both a good improvement in the brittleness of the brittle adhesive sheet 1 and a good suppression of matrix waste breaking.

From the viewpoint described above, the mass ratio of the HIPS resin and the GPPS resin (HIPS resin:GPPS resin) is preferably 50:1 to 1:5, more preferably 50:5 to 1:1, and even more preferably 50:5 to 50:15.

In addition, the rubber component included in the rubber component-containing polystyrene resin is not particularly limited, for example, it is possible to use a synthetic rubber such as acrylic rubber, acrylonitrile butadiene rubber, isoprene rubber, urethane rubber, ethylene propylene rubber, epichlorohydrin rubber, chloroprene rubber, styrene-butadiene rubber, butadiene rubber, polyisobutylene (butyl rubber) or a natural rubber, and to use one type or a combination of two or more types thereof.

Among the above, styrene-butadiene rubber or butadiene rubber is preferably used as the rubber component, and styrene-butadiene rubber is more preferably used. Due to this, in the brittle adhesive sheet 1, matrix waste breaking is particularly suppressed.

In addition, in a case where the rubber component includes styrene-butadiene rubber, the copolymerization ratio (styrene:butadiene) of styrene and butadiene, which are the monomer components of styrene-butadiene rubber, is preferably 30:70 to 60:40 in the mass ratio, and more preferably 35:65 to 55:45. Due to this, it is possible to make the flexibility of the film base material main body 11 sufficiently excellent and to particularly effectively suppress matrix waste breaking at the time of matrix removal of the brittle adhesive sheet 1. In addition, it is possible to make the rigidity of the film base material main body 11 sufficient and to make the workability at the time of sticking and peeling the brittle adhesive label produced from the brittle adhesive sheet 1 particularly easy. In addition, it is possible to suitably prevent the produced label from deteriorating due to environmental changes such as temperature and humidity changes.

The content ratio of the rubber component with respect to the total mass of the rubber component-containing polystyrene resin is more preferably 30% by mass or less, more preferably 20% by mass or less, and preferably 15% by mass or less. Due to this, it is possible to make the tensile elongation at break described above in the film base material main body 11 more preferable. As a result, the brittle adhesive sheet 1 exhibits excellent brittleness.

In addition, the content ratio of the polystyrene-based resin with respect to the total mass of the film base material main body 11 is preferably 66 to 100% by mass, and more preferably 70 to 95% by mass. Due to this, the brittleness of the brittle adhesive sheet 1 becomes better.

In addition, the film base material main body 11 may include a thermoplastic elastomer, but the content of the thermoplastic elastomer is preferably small. The content of the thermoplastic elastomer with respect to 100 parts by mass of the polystyrene-based resin of the film base material main body 11 is preferably 10 parts by mass or less, preferably 0 to 2 parts by mass, more preferably 0 to 0.5 parts by mass, and it is even more preferable that the thermoplastic elastomer not be substantially included. Due to this, the film base material main body 11 has reduced elasticity and reduced tear strength, and exhibits excellent brittleness.

Examples of thermoplastic elastomers that can be used for the film base material main body 11 include various thermoplastic elastomers such as styrene-based such as styrene-butadiene-styrene block copolymers, styrene-isoprene-styrene block polymers, polyolefin-based elastomers, polyvinyl chloride-based elastomers, polyurethane-based elastomers, polyester-based elastomers, polyamide-based elastomers, polybutadiene-based elastomers, trans polyisoprene-based elastomers, fluororubber-based elastomers, and chlorinated polyethylene-based elastomers, and it is possible to use one type or two or more types thereof in combination.

In addition, the film base material main body 11 may include a coloring agent. As the coloring agent, it is possible to use various pigments, dyes, and the like. In particular, in a case where a pigment is used as the coloring agent, it is possible to color the brittle adhesive sheet 1 and to make the brittle adhesive sheet 1 opaque, and the printability of the brittle adhesive sheet is improved. In a case where a pigment is used as the coloring agent, the pigment is insoluble in water and oil, thus, the pigment is dispersed in the film base material main body and it is possible to appropriately improve the brittleness of the brittle adhesive sheet.

The pigment is not particularly limited and examples thereof include inorganic pigments such as kaolin, clay, heavy calcium carbonate, light calcium carbonate, talc, titanium dioxide, barium sulfate, calcium sulfate, zinc oxide, silicic acid, silicates, colloidal silica, and satin white and organic pigments such as plastic pigments, and it is possible to use one type thereof or two or more types thereof in combination. Among these, in a case where a white pigment, particularly titanium dioxide, is used as the coloring agent, it is possible to make the brittle adhesive sheet 1 particularly opaque and to obtain a particularly high whiteness.

In addition, in such a case, the content ratio of the coloring agent with respect to the total mass of the film base material main body 11 is preferably 1.5 to 25% by mass, and more preferably 2.7 to 20% by mass. Due to this, while appropriately improving the brittleness of the film base material main body 11, it is possible to set the tear strength and the rigidity, and the suppression of the matrix waste breaking, to a sufficiently high degree, and to more reliably carry out coloring in the target color.

The thickness of the film base material main body 11 is preferably 10 to 120 μm, more preferably 25 to 100 μm, and even more preferably 40 to 80 μm. Due to this, the brittle adhesive sheet 1 has an appropriate rigidity and matrix waste breaking is particularly suppressed at the time of matrix removal. In addition, in the label produced using the brittle adhesive sheet 1, the entrainment of air bubbles and the generation of wrinkles are suitably prevented when attached to a housing such as an OA device.

In addition, when the produced strip-shaped brittle adhesive sheet 1 is wound, the occurrence of lifting between the pressure sensitive adhesive and the release liner is reliably prevented.

In the present specification, it is possible to acquire the “thickness” using a constant pressure thickness measuring device according to JIS K 7130 as a value represented by an average of thicknesses measured at five randomly selected points. Here, JIS K 7130 is a Japanese Industrial Standard created by translating ISO 4593, “Plastics-Film and sheeting-Determination of thickness by mechanical scanning”, without changing the technical content thereof.

Here, the thickness of the base material or layer means the total thickness of the base material or layer and, for example, in a case where the film base material main body is formed of a plurality of layers, the thickness means the total thickness of all the layers forming the film base material main body.

### (Print Receptive Layer)

The film base material 10 has the print receptive layer 16 provided at the second surface side opposite to the side where the adhesive layer 12 is provided, and the print receptive layer 16 includes a polyester-based resin or an acrylic-based resin.

In a case where printing is carried out on the print receptive layer, the printing ink is placed in direct contact with the print receptive layer. Therefore, the print receptive layer is preferably formed to have good adhesion to the printing ink (that is, excellent printability).

It is possible to form the print receptive layer on the target portion by applying a printing coating agent including each component for forming the print receptive layer and a diluting medium to the surface on which the print receptive layer is to be formed, and drying as necessary to volatilize the diluting medium. That is, the composition of the solid content (the component excluding the diluting medium) included in the printing coating agent corresponds to the constituent component of the print receptive layer. In the brittle adhesive sheet 1 of the embodiment, it is possible to coat a printing coating agent on the surface of the film base material main body 11 to provide the print receptive layer 16 on the film base material main body 11.

For the amount of coating of the printing coating agent on the film base material main body, usually, the thickness of the print receptive layer after drying is preferably 0.05 to 9 μm, more preferably 0.5 to 7 μm, and even more preferably 2 to 5 μm.

### Polyester-Based Resin

The printing coating agent may include a polyester-based resin as a resin component.

Examples of polyester-based resins include polyester resins, urethane-modified polyester resins, and the like.

Examples of polyester resins preferably include a polyester copolymer resin obtained by copolymerizing a dicarboxylic acid and a glycol compound.

As the dicarboxylic acid, it is possible to preferably use aromatic dicarboxylic acids such as terephthalic acid, phthalic acid, isophthalic acid, sulfoterephthalic acid, and 2,6-naphthalenedicarboxylic acid, and aliphatic dicarboxylic acids such as oxalic acid, sebacic acid, succinic acid, and adipic acid, alicyclic dicarboxylic acids such as 1,3-cyclohexanedicarboxylic acid, 1,3-cyclopentanedicarboxylic acid, 1,2-cyclohexanedicarboxylic acid, 1,2-cyclopentanedicarboxylic acid, and 1,4-cyclohexanedicarboxylic acid.

As the glycol compound, it is possible to preferably use ethylene glycol, 1,2-propylene glycol, 1,3-propanediol, 1,4-butanediol, neopentyl glycol, 1,6-hexanediol, 1,2-cyclohexanedimethanol, 1,4-cyclohexanedimethanol, p-xylene glycol, triethylene glycol, and the like.

Examples of urethane-modified polyester resins include resins having a urethane bond in the polyester resin described above.

It is possible to obtain the urethane-modified polyester resin, for example, by reacting a polyisocyanate compound with a polyester resin having two or more functional groups such as hydroxyl groups in one molecule.

As the polyisocyanate compound, it is possible to use the same polyisocyanate compound as a cross-linking agent described below. It is also possible to use the polyisocyanate compound used for the urethane modification of the polyester resin alone as one type or in a combination of two or more types.

A urethane-modified polyester resin is preferable as the polyester-based resin. Using the urethane-modified polyester resin makes it possible to widen the application range of the ink used for printing and further improve the adhesion to the ink.

The basic structure of the aromatic polyester has a repeating unit derived from an aromatic compound in the polyester structure of the main chain and may be obtained, for example, in a case where one or both of dicarboxylic acid and glycol compound of a part or all of the copolymerization raw material is an aromatic compound. The polyester-based resins may be used alone as one type or in a combination of two or more types thereof.

The number-average molecular weight of the polyester-based resin is preferably 5,000 to 100,000, and more preferably 10,000 to 60,000.

The hydroxyl value of the polyester-based resin is preferably 1 to 50 mgKOH/g, more preferably 1 to 25 mgKOH/g, and even more preferably 1.5 to 20 mgKOH/g.

The acid value of the polyester-based resin is preferably 0 to 40 mgKOH/g, and more preferably 0 to 30 mgKOH/g.

The glass transition temperature of the polyester-based resin is preferably 40 to 105° C., more preferably 50 to 100° C., and even more preferably 70 to 95° C.

When the number-average molecular weight, the hydroxyl value, the acid value, and the glass transition temperature of the polyester-based resin are in the preferable ranges described above, it is possible to further exhibit the effects of the present invention.

In addition, in order to satisfy both improvement of the adhesion of the print receptive layer to the film base material main body 11 and the printing ink and the prevention of blocking, it is possible to mix a polyester-based resin having a glass transition temperature lower than the glass transition temperature of the polyester-based resin described above by 20° C. or more in the polyester-based resin described above, and the glass transition temperature is preferably −30 to 15° C., and more preferably −25 to 5° C. When the glass transition temperature is in the preferable range or more preferable range described above, it is possible to further exhibit the effect of improving the adhesion of the print receptive layer and preventing blocking.

Examples of the polyester-based resin for improving the adhesion of the print receptive layer and preventing blocking include polyester resins, urethane-modified polyester resins and the like, in the same manner as in the polyester resins described above. In addition, preferable examples of the polyester-based resin for improving the adhesion of the print receptive layer and for preventing blocking include a polyester copolymer resin obtained by copolymerizing a dicarboxylic acid and a glycol compound. Specific examples of the dicarboxylic acid and glycol compound include the same examples as described above.

Examples of urethane-modified polyester resins include resins having a urethane bond in the polyester resin described above.

It is possible to obtain the urethane-modified polyester resin, for example, by reacting a polyisocyanate compound with a polyester resin having two or more functional groups such as hydroxyl groups in one molecule.

As the polyisocyanate compound, it is possible to use the same compounds as described above. It is also possible to use the polyisocyanate compound used for the urethane modification of the polyester resin alone as one type or in a combination of two or more types. The polyester-based resin for improving the adhesion of the print receptive layer and preventing blocking may be used alone as one type or in a combination of two or more types.

In a case where the polyester-based resin described above and the polyester-based resin for improving the adhesion of the print receptive layer and for preventing blocking are mixed and used, both are preferably the same type of polyester-based resin. For example, in a case where the former polyester-based resin is a urethane-modified polyester resin, the latter polyester-based resin for improving adhesion of the print receptive layer and preventing blocking used in combination therewith is also preferably a urethane-modified polyester resin, and, in a case where the former polyester-based resin is a urethane-modified polyester resin having a basic structure of an aromatic polyester, the latter polyester-based resin used for improving the adhesion to the print receptive layer and preventing blocking used in combination therewith is also preferably a urethane-modified polyester resin having the basic structure of an aromatic polyester.

As the number-average molecular weight, the hydroxyl value, and the acid value of the polyester-based resin for improving the adhesion of the print receptive layer and preventing blocking enter the following preferable ranges, more preferable ranges, and even more preferable ranges, it is possible to exhibit the effects of improving the adhesion of the print receptive layer and preventing blocking to an even greater extent.

The number-average molecular weight is preferably 5,000 to 100,000, and more preferably 10,000 to 60,000.

The hydroxyl value is preferably 1 to 50 mgKOH/g, more preferably 1 to 15 mgKOH/g, and even more preferably 1.5 to 10 mgKOH/g.

The acid value is preferably 0 to 20 mgKOH/g, more preferably 0 to 8 mgKOH/g, and even more preferably 0 to 3 mgKOH/g.

The mixing ratio of the polyester-based resin for improving the adhesion of the print receptive layer and preventing blocking is preferably 1 to 50% by mass with respect to 100% by mass of the total mass of all the polyester-based resins, more preferably 10 to 45% by mass, and particularly preferably 15 to 40% by mass.

It is possible for the printing coating agent to include an isocyanate-based compound as a cross-linking agent together with the polyester-based resin.

As the isocyanate-based compound as a cross-linking agent, it is possible to use various isocyanate-based compounds as long as the compounds react with a functional group such as a hydroxyl group of the polyester-based resin described above to form a cross-linked structure.

The isocyanate-based compound described above is preferably a polyisocyanate compound having two or more isocyanate groups per molecule.

Examples of polyisocyanate compounds include diisocyanate compounds, triisocyanate compounds, tetraisocyanate compounds, pentaisocyanate compounds, hexaisocyanate compounds, and the like, specifically, aromatic polyisocyanates such as tolylene diisocyanate, diphenylmethane diisocyanate, and xylylene diisocyanate; alicyclic isocyanate compounds such as dicyclohexylmethane-4,4-diisocyanate, bicycloheptane triisocyanate, cyclopentylene diisocyanate, cyclohexylene diisocyanate, methyl cyclohexylene diisocyanate, and hydrogenated xylylene diisocyanate; aliphatic isocyanate compounds such as pentamethylene diisocyanate, hexamethylene diisocyanate, heptamethylene diisocyanate, trimethylhexamethylene diisocyanate, and lysine diisocyanate, and the like.

In addition, it is also possible to use modified forms of these compounds such as biuret forms, isocyanurate forms, and adduct forms which are reaction products of these compounds with non-aromatic low-molecular-weight active hydrogen-containing compounds such as ethylene glycol, trimethylolpropane, and castor oil.

Among these isocyanate-based compounds, an aliphatic isocyanate compound is preferable, an aliphatic diisocyanate compound is more preferable, and pentamethylene diisocyanate, hexamethylene diisocyanate, and heptamethylene diisocyanate are particularly preferable.

The isocyanate-based compounds may be used alone as one type or in a combination of two or more types thereof.

The printing coating agent may include a metal-based cross-linking accelerator together with the isocyanate-based compound as the cross-linking agent.

Examples of metal-based cross-linking accelerators include a tin-based cross-linking accelerator, a bismuth-based cross-linking accelerator, a titanium-based cross-linking accelerator, a vanadium-based cross-linking accelerator, a zirconium-based cross-linking accelerator, an aluminum-based cross-linking accelerator, a nickel-based cross-linking accelerator, and the like.

Examples of tin-based cross-linking accelerators, bismuth-based cross-linking accelerators, titanium-based cross-linking accelerators, vanadium-based cross-linking accelerators, zirconium-based cross-linking accelerators, aluminum-based cross-linking accelerators, or nickel-based cross-linking accelerators include organometallic compounds of tin, bismuth, titanium, vanadium, zirconium, aluminum, or nickel, respectively, which are compounds having a structure such as an alkoxide, a carboxylate, or a chelate, and preferable examples include an acetylacetone complex, an acetylacetonate, an octyl acid compound, a naphthenic acid compound, or the like of the above metals.

Specific examples of metal acetylacetone complexes include acetylacetone titanium, acetylacetone vanadium, acetylacetone zirconium, acetylacetone aluminum, acetylacetone nickel, and the like.

Specific examples of acetylacetonate include bismuth acetylacetonate, titanium acetylacetonate, vanadium acetylacetonate, zirconium acetylacetonate, aluminum acetylacetonate, nickel acetylacetonate, and the like.

Specific examples of octylic acid compounds include bismuth 2-ethylhexylate, nickel 2-ethylhexylate, zirconium 2-ethylhexylate, and the like.

Specific examples of naphthenic acid compounds include bismuth naphthenate, nickel naphthenate, zirconium naphthenate, and the like.

The metal-based cross-linking accelerators may be used alone as one type or in a combination of two or more types thereof.

### Acrylic-Based Resin

The printing coating agent may include an acrylic-based resin as a resin component from the viewpoints of excellent adhesion to ink, high transparency, and excellent weathering resistance.

The acrylic-based resin is a resin including a structural unit derived from a monomer which forms the acrylic-based resin. Herein, “derived from” means that the monomer has undergone a structural change necessary for polymerization.

As the monomer which forms the acrylic-based resin, it is possible to exemplify monomers including (meth)acrylate, alkyl(meth)acrylates having a chain alkyl group and 1 to 18 carbon atoms, such as methyl(meth)acrylate, ethyl(meth)acrylate, propyl(meth)acrylate, butyl(meth)acrylate, 2-ethylhexyl(meth)acrylate, isooctyl(meth)acrylate, n-octyl(meth)acrylate, n-nonyl(meth)acrylate, isononyl(meth)acrylate, decyl(meth)acrylate, undecyl(meth)acrylate, dodecyl(meth)acrylate (lauryl(meth(meth)acrylate), tridecyl(meth)acrylate, tetradecyl(meth)acrylate (myristyl(meth)acrylate), pentadecyl(meth)acrylate, hexadecyl(meth)acrylate (palmityl(meth)acrylate), heptadecyl(meth)acrylate, and octadecyl(meth)acrylate (stearyl(meth)acrylate); (meth)acrylates having a cyclic skeleton such as cycloalkyl(meth)acrylate, benzyl(meth)acrylate, isobornyl(meth)acrylate, dicyclopentanyl(meth)acrylate, dicyclopentenyl(meth)acrylate, dicyclopentenyloxyethyl(meth)acrylate, and imide(meth)acrylate; hydroxy group-containing (meth)acrylates such as hydroxymethyl(meth)acrylate, 2-hydroxyethyl(meth)acrylate, and 2-hydroxypropyl(meth)acrylate; (meth)acrylic acid esters such as glycidyl group-containing (meth)acrylates such as glycidyl(meth)acrylate.

In addition, the acrylic-based resin may be a resin in which monomers are copolymerized such as acrylic acid, methacrylic acid, itaconic acid, vinyl acetate, acrylonitrile, styrene, and N-methylol acrylamide.

In this specification, “(meth)acrylate” is a concept encompassing both “acrylate” and “methacrylate”.

The monomer which forms the acrylic-based resin may be only one type, or two or more types.

The acrylic-based resin included in the print receptive layer may be a cross-linked acrylic-based resin cross-linked with a cross-linking agent.

The printing coating agent may include an acrylic-based resin and a cross-linking agent, and, from the viewpoint of reactivity, as the cross-linking agent, a polyfunctional epoxy-based cross-linking agent having two or more groups having an epoxy group or a glycidyl group in the molecule is preferable. The number of epoxy groups in one molecule in the cross-linking agent is 2 or more, and may be, for example, 2 to 6 or 3 to 5.

As the polyfunctional epoxy-based cross-linking agent, it is possible to use known cross-linking agents such as ethylene glycol diglycidyl ether, trimethylolpropane polyglycidyl ether, sorbitol polyglycidyl ether, and pentaerythritol polyglycidyl ether. These cross-linking agents are usually used alone or in a mixture of two or more types.

The acrylic-based resin may have a functional group that can bind to other compounds such as a vinyl group, a (meth)acryloyl group, an amino group, a hydroxyl group, a carboxyl group, and an isocyanate group. The acrylic-based resin preferably has a carboxyl group from the viewpoint of reactivity with the cross-linking agent. The carboxyl group may be derived from a carboxyl group in the monomer which forms the acrylic-based resin.

As the use amount of the carboxyl group-containing monomer used for the acrylic-based resin, it is possible to use a content of the structural unit derived from the carboxyl group-containing monomer of preferably 5% by mass or more with respect to the total mass (100% by mass) of the structural units forming the acrylic-based resin, preferably 5 to 50% by mass, and more preferably 10 to 40% by mass. When the content described above is 5 to 50% by mass, the water dispersibility of the acrylic-based resin and the cross-linking property with the epoxy-based cross-linking agent are good, and the water resistance and alkali resistance after the cross-linking reaction with the epoxy-based cross-linking agent are also good. Examples of carboxyl group-containing monomers include the (meth)acrylates described above and the like.

The acrylic-based resin preferably has a structural unit derived from an alkyl(meth)acrylate.

As the use amount of the alkyl(meth)acrylate used in the acrylic-based resin, it is possible to use a content of the structural unit derived from the alkyl(meth)acrylate of preferably 50% by mass or more with respect to the total mass (100% by mass) of the structural units forming the acrylic-based resin (C₁), preferably 50 to 95% by mass, and more preferably 60 to 90% by mass. When the content described above is 50 to 95% by mass, the obtained print receptive layer has a good balance between solvent resistance and water resistance. As the alkyl(meth)acrylate, it is possible to exemplify the examples described above and examples thereof include an alkyl(meth)acrylate having a chain alkyl group having 1 to 18 carbon atoms and an alkyl(meth)acrylate having 1 to 8 carbon atoms.

In addition, it is possible to use a monomer containing a basic nitrogen atom in order to improve the cross-linking reactivity between the acrylic-based resin and the epoxy-based cross-linking agent. As the use amount of the monomer containing a basic nitrogen atom, it is possible to use a content of the structural unit derived from the monomer containing a basic nitrogen atom of preferably 35% by mass or less with respect to the total mass (100% by mass) of the structural units forming the acrylic-based resin, and preferably 5 to 35% by mass. Examples of monomers containing a basic nitrogen atom include N,N-dimethylaminoethyl acrylate, N,N-diethylaminoethyl acrylate, dimethylaminoethyl methacrylate, N,N-diethylaminoethyl methacrylate, and the like, and the above are usually used alone or in a mixture of two or more types.

The acrylic-based resin is preferably a water-based acrylic-based resin provided in a state of being dissolved or dispersed in a solvent including water due to a high versatility in application to the film base material main body. The water-based resin may be a water-dispersed type or a water-soluble type.

It is possible to obtain the water-based acrylic-based resin by polymerization by a known method and it is possible to adopt a bulk polymerization method, a solution polymerization method, a suspension polymerization method, an emulsion polymerization method, or the like. For the production of the water-based acrylic-based resin, for example, a monomer having a hydrophilic group such as a carboxyl group may be used and after the polymerization reaction of the monomer is performed, it is preferable that the carboxyl group be neutralized and water be further added to the aqueous dispersion or aqueous solution.

Examples of the base used for neutralization include ammonia and primary or secondary amines and an imidazole compound is preferable from the viewpoint of improving the cross-linking reactivity described above. The imidazole compound encompasses imidazole and imidazole derivatives and the imidazole compound may be a compound in which one or more hydrogen atoms of imidazole are substituted with other groups.

Specific examples of imidazole compounds include 2-ethyl-4-methylimidazole, 1-benzyl-4-methylimidazole, 1-cyanoethyl-2-ethyl-4-methylimidazole, 1-cyanoethyl-2-isopropylimidazole, 2-methylimidazole, 2-ethylimidazole, imidazole, and the like.

It is possible to set the printing coating agent to a state in which an acrylic-based resin and an epoxy-based cross-linking agent are mixed. The acrylic-based resin and the cross-linking agent are preferably set to a state of being neutralized in advance to which water is further added to form an aqueous dispersion or aqueous solution.

The ratio of the content of the polyester-based resin or the acrylic-based resin with respect to 100% by mass of the total solid content of the printing coating agent (content of the polyester-based resin or acrylic-based resin of the print receptive layer) is preferably 20% by mass or more, preferably 20 to 95% by mass, more preferably 30 to 80% by mass, and even more preferably 40 to 70% by mass.

In a case where the printing coating agent includes a polyester-based resin, in the printing coating agent, the content ratio of the polyester-based resin and the isocyanate-based compound as a cross-linking agent is such that the isocyanate-based compound as a cross-linking agent is preferably 1 to 80 parts by mass with respect to 100 parts by mass of the polyester-based resin at a solid ratio, more preferably 2 to 70 parts by mass, and particularly preferably 3 to 60 parts by mass.

In addition, in a case where the printing coating agent includes a polyester-based resin, in the printing coating agent, the content ratio of the isocyanate-based compound as the cross-linking agent and the metal-based cross-linking accelerator is such that the metal-based cross-linking accelerator is preferably 0.001 to 5 parts by mass in terms of the amount of metal with respect to 100 parts by mass of the polyester-based resin, more preferably 0.005 to 2 parts by mass, and particularly preferably 0.01 to 1 part by mass.

In a case where the printing coating agent includes an acrylic-based resin, the blending ratio of the acrylic-based resin and the epoxy-based cross-linking agent is preferably adjusted such that the equivalent ratio of the carboxyl group of the acrylic-based resin before neutralization/the epoxy group of the epoxy-based cross-linking agent is 0.90 to 1.50. When the equivalent ratio is 0.90 to 1.50, the cross-linking reaction is sufficient and the obtained print receptive layer has good solvent resistance and water resistance.

Commercially available products may be used as the acrylic-based resin and the epoxy-based cross-linking agent and examples thereof include a water-based acrylic-based resin (trade name: Rikabond SA-95) and an epoxy-based cross-linking agent (trade name: Rikabond EX-8) from Japan Coating Resin Co., Ltd.

It is possible for the printing coating agent to include a diluting medium in addition to the polyester-based resin, the acrylic-based resin, the cross-linking agent, the cross-linking accelerator, and the base. Examples of diluting media include organic diluting media and water-based diluting media.

Examples of organic diluting media include aromatic hydrocarbons such as toluene and xylene, aliphatic ketones such as methyl ethyl ketone and diethyl ketone, and organic solvents such as alicyclic ketones such as cyclohexanone and it is possible to use the above as one type or as a combination of two or more types. In a case where two or more types are combined, combining organic solvents having different boiling points from 10 to 60° C. is preferable in terms of improving the drying efficiency.

Examples of water-based diluting media include water and a mixed solvent of water and a water-soluble organic solvent, and examples of water-soluble organic solvents include alcohols such as methyl alcohol, ethyl alcohol, and isopropyl alcohol.

The content ratio of resin solids such as the polyester-based resin or acrylic-based resin and the cross-linking agent with respect to the total mass of the printing coating agent is preferably 0.5 to 10% by mass, and more preferably 1 to 7% by mass.

In addition, it is possible to blend various fillers such as organic fillers and inorganic fillers in the printing coating agent in order to improve the slipperiness and obtain a matt feeling.

Examples of organic fillers include acrylic resins such as polystyrene resins, acrylonitrile-butadiene-styrene copolymer resins (ABS resin), polycarbonate resins, or methyl methacrylate, resin powders such as mixtures thereof, or the like.

Examples of inorganic fillers include inorganic oxides such as silica and alumina, metal powders such as gold powder and silver powder, and the like.

The blending amount of the filler is preferably 0.1 to 20 parts by mass with respect to 100 parts by mass of the total amount of the resin component of the printing coating agent and the cross-linking agent, and more preferably 0.5 to 10 parts by mass.

The gel fraction of the printing coating agent is preferably 50% or more 14 days after coating, and particularly preferably 60% or more. When the gel fraction is under this range, the cohesive strength of the printing coating agent becomes insufficient, which may cause cohesive failure of the print receptive layer. In addition, the ratio of the gel fraction after 14 days of coating with respect to the gel fraction after 3 days of coating (gel fraction after 14 days of coating/gel fraction after 3 days of coating) is preferably 4.5 or less, even more preferably 2.5 or less, and particularly preferably 1.5 or less. In this range, there is a possibility that the blocking resistance during production may be better.

Suitable printing methods for the print receptive layer are not particularly limited but examples thereof include offset printing, flexographic printing, ink jet printing, screen printing, thermal transfer printing, and the like.

### <Adhesive Layer>

The adhesive layer 12 is provided at the first surface side of the film base material 10.

In addition, the adhesive layer 12 has a function as a pressure sensitive adhesive, and it is possible to stick the brittle adhesive label formed from the brittle adhesive sheet 1 to the adherend by the adhesive layer 12.

The pressure sensitive adhesive that can be used for the adhesive layer 12 is not particularly limited and it is possible to use known pressure sensitive adhesives as one type or in a combination of two or more types.

The pressure sensitive adhesive is not particularly limited and examples thereof include pressure sensitive adhesives or the like in which the base resin is an acrylic-based pressure sensitive adhesive, a rubber-based pressure sensitive adhesive, a polyester-based pressure sensitive adhesive, or a silicone-based pressure sensitive adhesive. Among these, it is preferable to use an acrylic-based pressure sensitive adhesive. The acrylic pressure sensitive adhesive has excellent weathering resistance and can be obtained at a comparatively low cost.

The acrylic-based pressure sensitive adhesive includes an acrylic-based resin. It is possible to use a known acrylic-based polymer as the acrylic-based resin.

In a case where the acrylic-based pressure sensitive adhesive is an acrylic-based resin, the content ratio of the acrylic resin with respect to the total mass of the adhesive layer 12 may be 20 to 100% by mass, or may be 30 to 99.99% by mass.

As the acrylic-based resin, examples thereof include a polymer of a (meth)acrylic acid ester monomer, and a polymer of a (meth)acrylic acid alkyl ester monomer is preferable. It is more preferable to use a copolymer obtained by copolymerizing a (meth)acrylic acid alkyl ester monomer and a vinyl-based monomer. Due to this, the adhesive layer 12 has excellent weathering resistance and an appropriate adhesive strength.

In addition, the alkyl group of the (meth)acrylic acid alkyl ester monomer preferably has 4 to 12 carbon atoms. Due to this, the adhesive layer 12 has an appropriate adhesive strength.

Examples of (meth)acrylic acid alkyl ester monomers having an alkyl group having 4 to 12 carbon atoms include butyl(meth)acrylate, pentyl(meth)acrylate, hexyl(meth)acrylate, 2-ethylhexyl(meth)acrylate, isooctyl(meth)acrylate, decyl(meth)acrylate, and the like, and it is possible to use one type or a combination of two or more types.

In addition, specific examples of vinyl-based monomers include (meth)acrylic acid alkyl esters having an alkyl group having 1 to 3 carbon atoms; hydroxyl group-containing acrylic acid alkyl esters; α,β-unsaturated carboxylic acids such as (meth)acrylic acid, crotonic acid, and maleic acid; acrylamide; acrylonitrile; styrene; vinyl acetate; vinylpyrrolidone and the like, and it is possible to use one type or a combination of two or more types. Using such a vinyl-based monomer for the acrylic-based pressure sensitive adhesive makes it possible to adjust the adhesive strength or cohesive strength of the obtained pressure sensitive adhesive.

In addition, copolymerizing a mixture of the monomers as described above by a known method such as a solution polymerization method, an emulsion polymerization method, a suspension polymerization method, and a bulk polymerization method makes it possible to obtain a copolymer as an acrylic-based pressure sensitive adhesive.

It is possible to blend a cross-linking agent such as an isocyanate-based cross-linking agent, an epoxy-based cross-linking agent, a metal chelate-based cross-linking agent, or an aziridine-based cross-linking agent with the pressure sensitive adhesive described above. In a case where a cross-linking agent is blended with the pressure sensitive adhesive, an isocyanate-based cross-linking agent is particularly preferable.

Examples of isocyanate-based cross-linking agents include aromatic polyisocyanates such as tolylene diisocyanate, diphenylmethane diisocyanate, and xylylene diisocyanate, aliphatic polyisocyanates such as hexamethylene diisocyanate, alicyclic polyisocyanates such as isophorone diisocyanate and hydrogenated diphenylmethane diisocyanate, and the like, and examples thereof include biuret forms thereof, isocyanurate forms thereof, as well as adduct forms thereof, which are a reaction product with a low-molecular-weight active hydrogen-containing compound such as ethylene glycol, propylene glycol, neopentyl glycol, trimethylolpropane, or castor oil, and the like. These cross-linking agents may be used alone as one type or in a combination of two or more types.

In addition, examples thereof include epoxy compounds such as N,N,N′,N′-tetraglycidyl-m-xylenediamine, N,N,N′,N′-tetraglycidyl-4,4-diaminodiphenylmethane, 1,3-bis(N,N-diglycidylaminomethyl)cyclohexane, and 1,3-bis(N,N-diglycidylaminomethyl)toluene.

In order to obtain the required adhesive properties, the blending ratio of the cross-linking agent is preferably 0.01 to 5% by mass with respect to 100% by mass of the pressure sensitive adhesive, and particularly preferably 0.01 to 3.5% by mass (both are solid content conversion values).

In addition, the adhesive layer 12 may include various known additives as necessary such as tackifiers, fillers, antioxidants, heat stabilizers, ultraviolet absorbers, light stabilizers, coloring agents, flame retardants, and antistatic agents.

The adhesive strength of the adhesive layer in the brittle adhesive sheet of the embodiment is preferably 5 N/25 mm or more in the adhesive strength test described below, and more preferably 8 N/25 mm or more. When the adhesive strength of the adhesive layer is in the range described above, the adhesive strength to the adherend becomes good, and it is possible to easily break the brittle adhesive sheet 1 when peeling from the adherend.

According to ISO 29862:2007 (JIS Z 0237:2009), in the adhesive strength test, the test piece of the brittle adhesive sheet is stuck to the SUS304 steel plate (test panel) by pressing and moving a roller with a mass of 2 kg back and forth once thereon and, under the conditions of a peeling speed of 300 mm/min, measuring is carried out with a test method in which the test piece is peeled at 180° with respect to the test panel. The test piece of the brittle adhesive sheet which is used is reinforced with a pressure sensitive adhesive tape having a thickness of 25 μm as a base material of polyethylene terephthalate in order to prevent the film from breaking during the test. The size of the test piece is 25 mm wide and 100 mm long or more.

The thickness of the adhesive layer 12 is preferably 10 to 50 μm, and more preferably 15 to 40 μm. Due to this, while the label produced using the brittle adhesive sheet 1 has a sufficient adhesion (tack) and adhesive strength, the pressure sensitive adhesive is prevented from oozing at the end of the label at the time of sticking to the sticking target and dust is prevented from adhering to the pressure sensitive adhesive exposed on the end of the label.

### <Release Liner>

The release liner 13 is provided at the surface of the adhesive layer 12 opposite to the side where the film base material 10 is provided.

The release liner 13 is not particularly limited, and in general, it is possible to appropriately select and use a known release liner of which one surface of the liner is subjected to a release treatment. Examples of the liner that can be used as the release liner 13 include paper such as glassine paper, wood-free paper, and kraft paper, laminated paper in which a thermoplastic resin such as polyethylene is laminated on these papers, polyester films such as polyethylene terephthalate, polybutylene terephthalate, and polyethylene naphthalate, polyolefin films such as polyethylene and polypropylene, and the like.

In addition, as the release treatment agent for performing the release treatment, it is possible to exemplify silicone, long chain alkyl-based resin, fluorine-based resin, and the like.

The thickness of the release liner 13 is not particularly limited, but is preferably 10 to 150 μm, and preferably 20 to 130 μm.

It is possible to appropriately select the thickness of the brittle adhesive sheet 1 including the film base material 10 and the adhesive layer 12 excluding the release liner 13 according to the purpose, but 20 to 200 μm is preferable, 60 to 150 μm is more preferable, and 70 to 90 μm is particularly preferable.

The brittle adhesive sheet of the embodiment is preferably transparent. The preferably transparent part is the brittle adhesive sheet before printing is applied to the print receptive layer, or the part of the brittle adhesive sheet where the printing is not applied to the print receptive layer.

“Transparent” may be colored and transparent or colorless and transparent. As the indices of the transparency of the brittle adhesive sheet, it is possible to adopt the total light transmittance and haze below.

In addition, in a case where the brittle adhesive sheet of the embodiment is transparent, the print receptive layer of the brittle adhesive sheet preferably includes an acrylic-based resin from the viewpoint of high transparency and excellent weathering resistance.

### <Total Light Transmittance of Brittle Adhesive Sheet>

The total light transmittance of the brittle adhesive sheet is preferably 80% or more, and more preferably 85% or more. When the total light transmittance of the brittle adhesive sheet is the lower limit value or more, the visibility of the sticking target is improved and problems identifying the sticking target are less likely.

The upper limit value of the total light transmittance of the brittle adhesive sheet is not particularly limited, and higher is more preferable. In consideration of the ease of producing the brittle adhesive sheet, the high degree of freedom of the configuration of the brittle adhesive sheet, and the like, the total light transmittance of the brittle adhesive sheet is preferably 99% or less.

It is possible to measure the total light transmittance of the brittle adhesive sheet using a white LED (5V, 3 W) as a light source according to JIS K 7361-1:1997, as will be described below in Examples.

JIS K 7361-1:1997 is a Japanese Industrial Standard created by translating ISO 13468-1, “Plastics-Determination of the total luminous transmittance of transparent materials—Part 1: Single beam instrument” without changing the technical content thereof.

In a case where the brittle adhesive sheet is provided with a release liner, for the total light transmittance of the brittle adhesive sheet, the brittle adhesive sheet in the state after the release liner is peeled is the measurement target.

Here, for the total light transmittance of the brittle adhesive sheet, the brittle adhesive sheet before printing is applied to the print receptive layer, or the brittle adhesive sheet in a portion where the printing is not applied to the print receptive layer is the measurement target.

### <Haze of Brittle Adhesive Sheet>

The haze of the brittle adhesive sheet is not particularly limited, but is preferably 50% or less, more preferably 45% or less, and particularly preferably 40% or less. The polystyrene-based resin film of the related art includes a thermoplastic elastomer to prevent the matrix waste from being broken at the time of matrix removal, thus, the haze is greater than 50%; however, for the polystyrene-based resin film of the embodiment, the content of the thermoplastic elastomer is suppressed to 10 parts by mass or less, thus, it is possible to reduce the haze as compared with the related art. When the haze of the brittle adhesive sheet is the upper limit value or less, the visibility of the sticking target is improved and problems identifying the sticking target are less likely.

The lower limit value of the haze of the brittle adhesive sheet is not particularly limited, and lower is more preferable. In consideration of the ease of producing the brittle adhesive sheet, the high degree of freedom of the configuration of the brittle adhesive sheet, and the like, the haze of the brittle adhesive sheet may be 20% or more, or may be 30% or more.

It is possible to measure the haze of the brittle adhesive sheet using a white LED (5V, 3 W) as a light source according to JIS K 7136:2000.

JIS K 7136:2000 is a Japanese Industrial Standard created by translating ISO 14782 “Plastics-Determination of haze for transparent materials” without changing the technical content.

Here, in a case where the brittle adhesive sheet is provided with a release liner, for the haze of the brittle adhesive sheet, the brittle adhesive sheet in a state after the release liner is peeled is the measurement target.

Here, for the haze of the brittle adhesive sheet, the brittle adhesive sheet before printing is applied to the print receptive layer, or the brittle adhesive sheet in a portion where printing is not applied to the print receptive layer is the measurement target.

The brittle adhesive sheet or label may be stuck to anything.

The brittle adhesive sheet or label may be used for tampering prevention or unauthorized unsealing prevention. The brittle adhesive sheet or label may be stuck to a sticking target, and the contents such as characteristics and precautions for handling may be printed and displayed thereon. In addition, the brittle adhesive sheet or label may be used for the purpose of tracking or the like. In addition, the brittle adhesive sheet or label may be used by being stuck to the opening or opening portion (including an unsealing or portion to be opened) of an article for the purpose of certification, sealing, or the like. In addition, a brittle adhesive sheet or label may be an unauthorized unsealing prevention seal used by sticking to an open sealing portion or opening portion of the article, in order to prevent improper unpacking, opening, unsealing, or unsealing of an open sealing portion such as a lid or an opening portion of the article. In addition, the brittle adhesive sheet or label may be used for the purpose of preventing counterfeiting of products and preventing distribution of counterfeit products. For example, for the purpose described above, the brittle adhesive sheet or label may be printed with a barcode for identifying an article, a code such as a QR code (registered trademark), an identification number, an identification symbol, or the like.

As examples of articles to which brittle adhesive sheets or labels are attached, it is possible to exemplify pharmaceuticals, cosmetics, medical equipment, medical products, OA devices, home electrical appliances, desks, cabinets, safes, baggage, envelopes, and paper packaging materials or cardboard packaging materials thereof. Among these, the brittle adhesive sheet or label is suitable as a label that can enclose a container or package of a medicine and track the medicine.

In addition, in a case of being stuck to OA devices, home electric appliances, or the like, for the housing of OA devices and home electric appliances, generally, polystyrene-based resins such as polystyrene (PS), acrylonitrile butadiene styrene (ABS), or the like are used. Forming the brittle adhesive sheet of the same type of resin as the housing makes it unnecessary to peel the sheet from the housing when recycling the housing. That is, in a case where the housing is disassembled and classified, impurities other than the polystyrene-based resin are less likely to be mixed therein due to the presence of the label. For this reason, in a case where the label is used, it is possible to simplify the operation at the time of recycling.

As one embodiment of the present invention, a sticking method for sticking the brittle adhesive sheet or label of the embodiment to an article which is a sticking target is provided.

As one embodiment of the present invention, a method for producing an article is provided, in which the brittle adhesive sheet or label of the embodiment is stuck to an article which is a sticking target.

As one embodiment of the present invention, a method for preventing tampering is provided, in which the brittle adhesive sheet or label of the embodiment is stuck to an article which is a sticking target.

As one embodiment of the present invention, a method for preventing counterfeiting is provided, in which the brittle adhesive sheet or label of the embodiment is stuck to an article which is a sticking target.

As one embodiment of the present invention, an unauthorized unsealing prevention method is provided, in which the brittle adhesive sheet or label of the embodiment is stuck to an article which is a sticking target.

As a method for sticking the brittle adhesive sheet of the embodiment to the article which is a sticking target, the adhesive layer of the brittle adhesive sheet or label may be brought into contact with the surface of the article which is the sticking target such that the brittle adhesive sheet or label is stuck to the article.

As one embodiment of the present invention, a use of the brittle adhesive sheet or label of the embodiment for tampering prevention is provided.

As one embodiment of the present invention, a use of the brittle adhesive sheet or label of the embodiment for preventing counterfeiting is provided.

As one embodiment of the present invention, a use of the brittle adhesive sheet or label of the embodiment for preventing unauthorized unsealing is provided.

### Method for Producing Brittle Adhesive Sheet>>

Next, a description will be given of a method for producing the brittle adhesive sheet of the embodiment.

The method for producing the brittle adhesive sheet of the embodiment has a base material main body-forming step of forming a film base material main body formed of a polystyrene-based resin, an adhesive layer-forming step of forming an adhesive layer at the first surface side of the film base material main body, and a print receptive layer-forming step of forming a print receptive layer including a polyester-based resin or an acrylic-based resin at the second surface side of the film base material main body. Due to this, it is possible to easily and reliably produce the brittle adhesive sheet 1 as described above.

### <Base Material Main Body-Forming Step>

It is possible to obtain the film material forming the film base material main body 11 by kneading and mixing the constituent materials of the film base material main body 11.

The film material may be a material in which each of the materials forming the film base material main body 11 are mixed all at the same time or in which a part of the constituent components of the film material to be prepared may be mixed in advance to obtain a mixture (master) and then the mixture (master) may be mixed with other components.

For example, in a case where the film material includes a coloring agent, a coloring agent and a part of the styrene-based resin may be mixed in advance to obtain a masterbatch of the coloring agent, and the masterbatch of the coloring agent and other constituent materials may be mixed to obtain the film material. Due to this, it is possible to more uniformly mix the coloring agent in the film material and the obtained film base material main body 11 becomes more uniformly colored at each portion.

In particular, in a case where a pigment is used as the coloring agent, the content ratio of the pigment with respect to 100% by mass of the masterbatch of the coloring agent is preferably 30 to 60% by mass, and more preferably 35 to 55% by mass. Due to this, it is possible to more uniformly disperse the pigment and to uniformly color the formed film base material main body 11 and the generation of foreign matter (fish eyes) or the like in which the pigment is aggregated is reliably prevented.

In addition, such a masterbatch of the coloring agent is preferably mixed as 5 to 30 parts by mass with respect to 100 parts by mass of the remaining styrene-based resin, and more preferably mixed as 10 to 20 parts by mass. Due to this, it is possible to more reliably color the film base material main body 11.

In the present embodiment, the film base material main body 11 formed of a polystyrene-based resin is preferably formed by uniaxial stretching of the film material described above. By forming the film base material main body 11 by uniaxial stretching, the film base material main body 11 reliably satisfies the strength ratio as described above in the tear strength test as described above. It is considered that this is because the polystyrene-based resin is oriented in the stretching direction in the film formed by uniaxial stretching. As a result, it is considered that the brittle adhesive sheet 1 using the film base material main body 11 more suitably satisfies both the tampering or unauthorized unsealing prevention effect and the suppression of matrix waste breaking.

### <Adhesive Layer-Forming Step>

The adhesive layer 12 is formed at the first main surface of the film base material main body 11.

In the brittle adhesive sheet 1 of the embodiment, it is possible to form the adhesive layer 12 by forming a sheet-shaped adhesive layer (precursor) of the pressure sensitive adhesive constituent material on the release liner 13, and bonding the release liner 13 and the film base material main body 11 such that the adhesive layer (precursor) comes therebetween.

It is possible to form the adhesive layer (precursor), for example, by applying a coating liquid including each component for forming the adhesive layer and a diluting medium onto the release liner 13 and drying.

The solid content of the coating liquid is preferably 20 to 60% by mass, and more preferably 25 to 55% by mass. Due to this, it is possible to form the adhesive layer having a more uniform thickness.

It is possible to coat the coating liquid, for example, by a coating machine (coater). The coating machine that can be used for coating the coating liquid is not particularly limited and examples thereof include an air knife coater, a blade coater, a bar coater, a gravure coater, a roll coater, a curtain coater, a die coater, a knife coater, a screen coater, a kiss coater, and the like.

Next, the release liner 13 provided with the adhesive layer (precursor) and the film base material main body 11 are bonded together such that the adhesive layer (precursor) is interposed between the release liner 13 and the film base material main body 11 to form the adhesive layer 12 on the film base material main body 11.

### <Print Receptive Layer-Forming Step>

The print receptive layer is formed at the second main surface of the film base material main body 11.

It is possible to form the print receptive layer on the target portion by applying a printing coating agent including each component for forming the print receptive layer and a diluting medium to the surface on which the print receptive layer is to be formed, and drying as necessary to volatilize the diluting medium. In the brittle adhesive sheet 1 of the embodiment, it is possible to coat the printing coating agent at the second surface side of the film base material main body 11 to provide the print receptive layer 16 on the film base material main body 11.

By directly coating the printing coating agent on the film base material main body 11 in this manner, in a case where the printing coating agent includes an organic diluting medium (organic solvent), the organic diluting medium comes into contact with the film base material main body 11. By doing so, the film base material main body comes into contact with the organic solvent such that part of the surface is likely to be dissolved and swelled, thus, the familiarity of the components of the printing coating agent and the film base material main body becomes good and the adhesion of the print receptive layer to the film base material main body is improved. In the film base material main body formed of a polystyrene-based resin, softening occurs easily due to an organic solvent and due to the combination of the structure of a polystyrene-based resin and the print receptive layer, the adhesion of the print receptive layer is excellent and the film base material 10 with high printability is obtained.

In a case where a water-based diluting medium is included in the printing coating agent, softening of the film base material main body or the like due to the water-based diluting medium does not easily occur, thus, it is possible to improve the degree of freedom in the configuration of the film base material main body thickness and, for example, it is possible to easily produce the film base material 10 having excellent brittleness.

Examples of a method for coating the printing coating agent described above include methods known in the related art such as a bar coating method or a gravure coating method.

In order to increase the adhesion of the printing coating agent to the film base material main body, it is possible to provide an anchor coating layer on the surface of the film base material main body as necessary and to provide the print receptive layer on the surface of the anchor coating layer.

Examples of the anchor coating agent used to provide the anchor coating layer include a polyurethane-based anchor coating agent, a polyester-based anchor coating agent, and the like.

Drying is usually preferably performed at 60 to 130° C., and more preferably 70 to 120° C.

The drying time is not particularly limited, but 10 seconds to 5 minutes is usually sufficient.

The back surface of the film base material main body may be subjected to an easy-adhesion treatment in order to further improve the adhesion with the adhesive layer. The easy adhesion treatment is not particularly limited and examples thereof include a corona discharge treatment and the like.

The print receptive layer-forming step is preferably performed after the adhesive layer-forming step. By first performing the adhesive layer-forming step and laminating the adhesive layer and the release liner on the film base material main body, the risk of damaging the brittle film base material main body in the print receptive layer-forming step is reduced.

The brittle adhesive sheet 1 is obtained by going through each of the steps described above.

### Method for Producing Label

Next, a description will be given of a method for producing a label using the brittle adhesive sheet 1.

It is possible for the method for producing a label of the embodiment to include a die cutting step of forming a label portion and a matrix waste portion by forming a cut line in the film base material and the adhesive layer of the brittle adhesive sheet, and a matrix removal step of removing the matrix waste portion. It is possible for the method for producing a label of the embodiment to further include a printing step of performing a printing process on the print receptive layer of the brittle adhesive sheet or the label portion. A description will be given below of a method for producing a label including a printing step.

First, a printing process is performed on the print receptive layer 16 of the brittle adhesive sheet 1.

Next, the film base material 10 and the adhesive layer 12 of the brittle adhesive sheet 1 are die cut using a cutting die (die) in accordance with the periphery of the print pattern, so as to form the label portion 14 having a shape corresponding to the label and the matrix waste portion 15 in the other portions. The label portion 14 and the matrix waste portion 15 include the film base material 10 and the adhesive layer 12.

At this time, it is preferable that no cut be formed in the release liner 13. A cut may be formed in the release liner 13, but not to the extent that the release liner is broken.

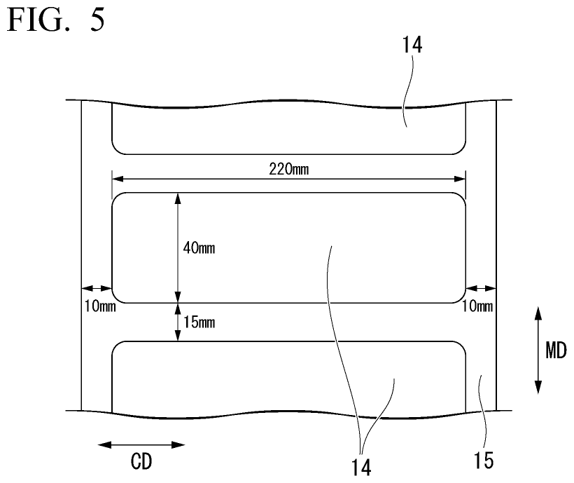

From the viewpoint that the suppression of matrix waste breaking is effectively exhibited and the amount of excess matrix waste portions is reduced due to the brittle adhesive sheet according to the embodiment, the width of the matrix waste portion is preferably narrow. On the other hand, providing a certain amount of a matrix waste portion improves the operation efficiency of the label sticking operation. Therefore, the width of the matrix waste portion formed along the MD direction where matrix waste breaking is easily generated may be, for example, 1 to 20 mm, and may be 3 to 10 mm. (The width in FIG. 5 described below is 10 mm.) Here, the width of the matrix waste portion formed along the MD direction described above is the minimum value of the width values of the matrix waste portion measured along the CD direction.

Next, the matrix waste portion 15 is peeled (matrix removal) from the release liner 13 to obtain a label in which the label portion 14 remains on the release liner 13.

It is possible to efficiently and continuously perform the peeling of the matrix waste portion 15 by, for example, using a matrix removal winder or the like. It is possible to perform the matrix removal along the MD described above. In a case where a brittle adhesive sheet of the related art is used, there is a problem in that the matrix waste portion is broken and matrix waste breaking frequently occurs during matrix removal. When matrix waste breaking frequently occurs in this manner, it is necessary to interrupt the matrix removal every time the matrix waste breaking occurs and prepare the matrix removal winding again, which is a problem in that it is not possible to efficiently produce the labels. However, in the brittle adhesive sheet of the embodiment, matrix waste breaking is suitably prevented. Therefore, it is possible to produce the label without interrupting the matrix removal operation.

Here, a description was given of performing the printing process at the time of producing the label, but the printing process may be performed on the print receptive layer 16 of the brittle adhesive sheet 1 to provide a brittle adhesive sheet for which the printing process is completed.

In addition, the printing process may be directly performed on the label after the matrix removal using a thermal transfer labeler, or the brittle adhesive sheet or the label may be produced without performing the printing process.

### <<Label>>

Next, a description will be given of a label produced using the brittle adhesive sheet 1.

It is possible to obtain the label of the embodiment by processing the brittle adhesive sheet 1 as described above.

Examples of the configuration of the label of the embodiment include the examples exemplified in the embodiment of the brittle adhesive sheet, and the configuration may be provided with a film base material, and an adhesive layer provided at the first surface side of the film base material, in which the film base material may be provided with a film base material main body formed of a polystyrene-based resin, and a print receptive layer provided at the second surface side of the film base material opposite to the side where the adhesive layer is provided, and the print receptive layer may include a polyester-based resin or an acrylic-based resin.

In the label of the embodiment, printing is preferably carried out on the print receptive layer. Accordingly, in the label of the embodiment, the printing ink is preferably laminated on the print receptive layer.

In the label of the embodiment, a plurality of brittle adhesive sheets (label portions) of the embodiments may be arranged in the form of islands on a release liner.

The number of brittle adhesive sheets (label portion) arranged in the form of islands on the release liner may be 2 or more, 50 or more, or 1000 or more. The upper limit value of the number depends on the size of the brittle adhesive sheet, but is, for example, 1,000,000 or less.

The area of each of the label portions 14 described above may be, for example, 1 to 100 cm², 2 to 50 cm², or 5 to 40 cm².

The label may be stuck to anything and examples of sticking targets include those described for the brittle adhesive sheet.

By providing the brittle adhesive sheet processed into a label, it is possible to expect an improvement in the operation efficiency of the sticking operation.

Embodiments were described above, but the present invention is not limited thereto.

In addition, for example, the brittle adhesive sheet of the present invention may be provided with an optional layer in addition to the layers exemplified above. For example, an intermediate layer may be provided between the adhesive layer and the film base material main body or between the film base material main body and the print receptive layer for the purpose of improving the adhesion and the like.

In addition, in the embodiment described above, the adhesive layer was provided by being formed on the release liner temporarily and then bonding the release liner and the film base material main body 11, but the method for forming the adhesive layer is not limited thereto. For example, the adhesive layer may be provided by bonding an adhesive sheet including a pressure sensitive adhesive on the film base material main body 11, or may be provided by directly coating the coating liquid as described above on the film base material.

### EXAMPLES

Next, a more detailed description will be given of the present invention with reference to Examples, but the present invention is not limited to the following Examples.

### 1. Production of Brittle Adhesive Sheet

### Example 1-1

### (a) Film Base Material Main Body-Forming Step

First, a polystyrene resin (HIPS) was prepared by graft-polymerizing 90 parts by mass of styrene monomer and 10 parts by mass of styrene-butadiene rubber.

Next, 7.5 parts by mass of polystyrene resin (HIPS) and 7.5 parts by mass of titanium dioxide were mixed to obtain a masterbatch of a coloring agent.

Next, 100 parts by mass of polystyrene resin (HIPS) and 15 parts by mass of the masterbatch of the coloring agent were mixed to obtain a white film material.

Next, the film material melted at 140° C. was stretched (uniaxially stretched) in the MD direction using a T-die film-forming machine to obtain a uniaxially stretched film having a thickness of 50 μm.

Next, one surface of the uniaxially stretched film was subjected to corona discharge treatment to obtain a film base material main body.

### (b) Adhesive Layer-Forming Step

Next, an acrylic pressure sensitive adhesive (a mixture of 100 parts by mass of a copolymer of acrylic acid ester having a weight-average molecular weight of 500,000 in which 95 parts by mass of butyl acrylate and 5 parts by mass of acrylic acid were mixed, and 0.03 parts by mass of an epoxy-based cross-linking agent (TETRAD-C, produced by Mitsubishi Gas Chemical Co., Inc.)) was coated on the release liner and dried at 90° C. for 60 seconds to form an adhesive layer having a dry thickness of 30 μm and obtain a laminate formed of the release liner and an adhesive layer.

Next, an adhesive layer was formed on the film base material by bonding the surface of the laminate having the adhesive layer and the surface of the film base material subjected to a corona discharge treatment.

### (c) Print Receptive Layer-Forming Step

70 parts by mass of urethane-modified polyester resin A (produced by Toyobo Co., Ltd., Vylon UR-1700, hydroxyl value 19 mgKOH/g, glass transition temperature 92° C., solid content 30% by mass), 30 parts by mass of urethane-modified polyester resin B (produced by Toyobo Co., Ltd., Vylon UR-8700, hydroxyl value 2-4 mgKOH/g, glass transition temperature −22° C., solid content 30% by mass), 15 parts by mass of isocyanate-based cross-linking agent (Tosoh Corporation, Coronate HX, solid content 100% by mass)), and 2 parts by mass of a tin-based cross-linking accelerator solution (solid content 25% by mass) were mixed and diluted with toluene to obtain a coating liquid having a solid content of 1.5% by mass.

A print receptive layer having a thickness of 2 μm was formed by applying the coating liquid to the film base material and drying at 70° C.

Table 1 shows the material, content, and the like of the film base material produced in Example 1-1.

TABLE 1

| Composition of film base | | Composition of print | | | |
|---|---|---|---|---|---|
| material main body | | receptive layer [% by mass] | | | |
| [% by mass] | | Polyester- | Polyester- | Cross- | Cross- |
| Polystyrene | Coloring | based | based | linking | linking |
| resin | Agent | resin A | resin B | agent | accelerator |
| 93 | 7 | 46 | 20 | 33 | 1 |

### Example 2-1

A brittle adhesive sheet was produced in the same manner as in Example 1-1 except that the thickness of the print receptive layer was changed to 4 μm.

### Comparative Example 1-1

An adhesive sheet was produced in the same manner as in Example 1-1, except that the print receptive layer was not provided.

### Comparative Example 2-1

An adhesive sheet was produced in the same manner as in Comparative Example 1-1, except that the surface of the film base material was subjected to a corona treatment.

### Comparative Example 3-1

A film was produced in the same manner as in Comparative Example 1-1, except that a film base material produced by an inflation method (biaxial stretching) was used instead of the film base material described above. In the inflation method, film formation was performed using an inflation processing machine (die diameter 75φ) under conditions of a resin temperature of 220° C. and a die temperature of 200° C.

### Comparative Example 4-1

An adhesive sheet was produced in the same manner as in Comparative Example 1-1, except that stretching was not carried out in the T-die method of Comparative Example 1-1.

### Example 1-2

### (a) Film Base Material Main Body-Forming Step

First, polystyrene resin (HIPS) pellets were obtained by graft-polymerizing 90 parts by mass of styrene monomer and 10 parts by mass of styrene-butadiene rubber.

Next, polystyrene resin (GPPS) pellets were obtained by polymerizing 100 parts by mass of styrene monomer.

Next, 100 parts by mass of polystyrene resin (HIPS) pellets and 15 parts by mass of polystyrene resin (GPPS) pellets were mixed to obtain a transparent film material.

Next, the film material melted at 140° C. was stretched (uniaxially stretched) in the MD direction using a T-die film-forming machine to obtain a uniaxially stretched film having a thickness of 50 μm.

Next, one surface of the uniaxially stretched film was subjected to a corona discharge treatment to obtain a film base material main body.

### (b) Adhesive Layer-Forming Step

An adhesive layer was formed on the film base material in the same manner as in Example 1-1 described above.

### (c) Print Receptive Layer-Forming Step

100 parts by mass of a water-based acrylic-based resin (Japan Coating Resin Co., Ltd., Rikabond SA-95, solid content 20.5% by mass), and 10 parts by mass of an epoxy-based cross-linking agent (Japan Coating Resin Co., Ltd., Rikabond EX-8, solid content 100% by mass) were mixed and diluted with water to obtain a coating liquid having a solid content of 10% by mass.

A print receptive layer having a thickness of 2 μm was formed by coating the coating liquid on the film base material and drying at 120° C.

### Example 2-2

A brittle adhesive sheet was produced in the same manner as in Example 1-2 except that the thickness of the print receptive layer was changed to 4 μm.

### Comparative Example 1-2

An adhesive sheet was produced in the same manner as in Example 1-2 except that the print receptive layer was not provided.

### Comparative Example 2-2

An adhesive sheet was produced in the same manner as in Comparative Example 1-2 except that the surface of the film base material was subjected to a corona treatment.

### Comparative Example 3-2

A film was produced in the same manner as in Comparative Example 1-2, except that a film base material produced by an inflation method (biaxial stretching) was used instead of the film base material described above. In the inflation method, film formation was performed using an inflation processing machine (die diameter 75φ) under conditions of a resin temperature of 220° C. and a die temperature of 200° C.

### Comparative Example 4-2

An adhesive sheet was produced in the same manner as Comparative Example 1-2 except that stretching was not carried out in the T-die method of Comparative Example 1-2.

### 2. Evaluation

### 2.1 Tensile Elongation at Break

The tensile elongation at break of the film base materials of each of the Examples and Comparative Examples was measured according to JIS Z 0237:2009.

In the machine direction (MD) of the film base material, a test piece of the film base material die cut into a strip shape having a width of 15 mm and a marked line length of 100 mm was prepared. Next, using a tensile tester, the test piece was pulled at a speed of 200 mm/min at a temperature of 23° C. and a humidity of 50% RH, the length of the test piece at break was measured, and the elongation [%] with respect to the length of the original test piece was determined.

### 2.2 Tensile Strength at Break

The tensile strength at break of the film base material of each Example and each Comparative Example was measured according to JIS Z 0237:2009.

Regarding the machine direction (MD) of the film base material, a test piece of the film base material die cut into a strip shape with a width of 15 mm and a marked line length of 140 mm was prepared. Next, a tensile tester was used to pull the test piece at a speed of 200 mm/min at a temperature of 23° C. and a humidity of 50% RH to determine the tensile strength at break.

### 2.3 Tear Strength Test

For the film base material of each Example and each Comparative Example, a tear strength test was performed at a test speed of 300 mm/min according to the Trouser Tear Method according to JIS K 7128-1:1998 in the machine direction (MD) and the cross machine direction (CD) at 90° to the machine direction and the value obtained by dividing the obtained load (mN) by the thickness (mm) was taken as the tear strength.

### 2.4 Brittleness

Regarding the brittle adhesive sheet of each Example and each Comparative Example, a test piece of the brittle adhesive sheet die cut into a rectangle of 50 mm×50 mm was prepared. The test piece peeled from the release liner was stuck to the surface of the acrylic plate and the test piece was left for 24 hours at room temperature, then the state of the test piece was evaluated according to the following criteria when peeling was carried out from the corner portions of the test piece.

A: The test piece was fragmented by the time the peeling of the test piece was completed.

C: The test piece was completely peeled without fragmentation.

### 2.5 Matrix Waste Breaking Property

A label die cutting process was performed on the brittle adhesive sheets obtained in each Example and each Comparative Example in a pattern shown in FIG. 5 using a label-printing machine (Intermitted Letterpress machine) “LPM-300iT (Lintec Corporation) equipped with an offset printing device, a die-cutting device, and a matrix removal/winding device and label portions and a matrix waste portion were formed. Thereafter, matrix removal was performed and the matrix waste portion was wound in the longitudinal direction so as to evaluate the matrix waste breaking property according to the following four-stage criteria.

A: No matrix waste left.

B: Matrix waste break occurs at a frequency of once every 20 μm or more and less than 200 μm.

C: Matrix waste break occurs at a frequency of once every less than 5 μm.

### 2.6 Printability

With respect to the brittle adhesive labels of each Example and each Comparative Example, the printing state was evaluated according to the following criteria.

A: Uniform solid printing was completed.

C (Poor adhesion): Ink peeling occurred due to insufficient adhesion of the printing ink to the film base material.

C (Unevenness): Unevenness occurred in the solid coating of the printing ink

Table 2 shows these results.

TABLE 2

| | | | | | | Tensile properties | | | | | | | |
|---|---|---|---|---|---|---|---|---|---|---|---|---|---|
| | | | | Surface | | | Strength | Tearing | | | | | |
| | | | | treatment | | Elongation | at break | physical properties | | | | | |
| | | | | Print | | at break | [N/15 | Strength | | Strength | | | |
| | | Film | Method for | receptive | | [%] | mm] | [mN/mm] | | ratio | Brittle- | Matrix | Print- |
| | | type | forming film | layer coat | Corona | MD | | MD | CD | MD/CD | ness | breaking | ability |
| Example 1-1 | White | PS | T die method | 2 μm | — | 3 | 30 | 680 | 2000 | 0.34 | A | A | A |
| Example 2-1 | White | PS | T die method | 4 μm | — | 5 | 31 | 700 | 220 | 0.32 | A | A | A |
| Comparative | White | PS | T die method | None | None | 2 | 25 | 700 | 1700 | 0.41 | A | B | C*1 |
| Example 1-1 | | | | | | | | | | | | | |
| Comparative | White | PS | T die method | None | Yes | | 25 | 700 | 160 | 0.44 | A | B | C*2 |
| Example 2-1 | | | | | | | | | | | | | |
| Comparative | White | PS | Inflation | None | None | 10 | 21 | 1700 | 1900 | 0.89 | C | A | C*1 |
| Example 3-1 | | | method | | | | | | | | | | |
| Comparative | White | PS | T die method | None | None | | 20 | 700 | 800 | 0.88 | A | C | C*1 |
| Example 4-1 | | | (no stretching) | | | | | | | | | | |
| Example 1-2 | Transparent | PS | T die method | 2 μm | — | 4 | 31 | 900 | 2100 | 0.43 | A | A | A |
| Example 2-2 | Transparent | PS | T die method | 4 μm | — | 5 | 32 | 970 | 2200 | 0.44 | A | A | A |
| Comparative | Transparent | PS | T die method | None | None | 3 | 30 | 1000 | 1700 | 0.59 | A | B | C*1 |
| Example 1-2 | | | | | | | | | | | | | |
| Comparative | Transparent | PS | T die method | None | Yes | 3 | 30 | 1000 | 1700 | 0.59 | A | B | C*2 |
| Example 2-2 | | | | | | | | | | | | | |
| Comparative | Transparent | PS | Inflation | None | None | LS | 25 | 1900 | 2000 | 0.95 | C | A | C*1 |
| Example 3-2 | | | method | | | | | | | | | | |
| Comparative | Transparent | PS | T die method | None | None | 3 | 20 | 800 | 900 | 0.89 | A | C | C*1 |
| Example 4-2 | | | (no stretching) | | | | | | | | | | |

*1 Poor adhesion
*2 Unevenness

### 2.7 Transparency

The total light transmittance and haze of the adhesive sheets of Examples 1-2 to 2-2 were determined.

For the total light transmittance, the total light transmittance of the adhesive sheet peeled from the release liner was measured according to JIS K 7361-1:1997 using a haze meter (NDH5000 produced by Nippon Denshoku Industries Co., Ltd.).

The haze was measured using a haze meter (NDH5000 produced by Nippon Denshoku Industries Co., Ltd.) according to JIS K 7136:2000.

As a result, the adhesive sheets of Examples 1-2 to 2-2 all had a total light transmittance of 90% and all had a haze of 38%, and the transparency was good.

Below, Example 1-1 and Example 1-2 may be collectively referred to as Example 1. The same applies to the other Examples and Comparative Examples.

As shown in Table 2, according to the comparison between Examples 1 and 2 and Comparative Examples 1 and 2, the adhesive sheets of Examples 1 and 2 provided with the print receptive layer on the surface obtained good results in all items of brittleness, matrix waste breaking, and printability. It is considered that providing the print receptive layer on the surface naturally improved the printability, but also likely improved the tear strength mainly in CD, which suppresses matrix waste breaking. On the other hand, it is considered that the tear strength in the MD of the films of Examples 1 and 2 is not greatly changed from that of the films of Comparative Examples 1 and 2, the brittleness of the adhesive sheet is maintained while the matrix waste breaking is suppressed, and the brittleness and the suppression of matrix waste breaking are both satisfied.

Regarding the tensile properties, it is considered that the tensile elongation at break and tensile strength at break of the adhesive sheets of Examples 1 and 2 are significantly lower than the numerical values of general adhesive sheets and that each value is important for exhibiting the brittleness of the adhesive sheet.

In addition, in Comparative Example 3, it is understood that the tear strength is a high value in both MD and CD and the matrix waste breaking is suppressed, but the brittleness is reduced. In Comparative Example 4, it is understood that the tear strength is a low value in both MD and CD and the brittleness is good, but the tear strength of CD is small, therefore the generation of matrix waste breaking tends to increase.

In the white adhesive sheets of Example 1-1 to Comparative example 4-1, titanium dioxide was used as the white coloring agent and the titanium dioxide powder was dispersed in the film base material to lower these physical properties and it is considered that this contributed to an improvement in the brittleness.

On the other hand, with the transparent adhesive sheets of Example 1-2 to Comparative Example 4-2, it was possible to obtain a highly transparent adhesive sheet without using a white coloring agent. At this time, it is considered that the use of a mixture of HIPS and GPPS as the polystyrene resin instead of using the white coloring agent also contributed to the improvement in the brittleness.

It is possible to freely combine the upper limit value and the lower limit value of the numerical range exemplified in the present specification.

Each configuration, combination thereof, and the like in each embodiment are examples, and it is possible to make additions, omissions, replacements, and other changes to the configurations thereof without departing from the spirit of the present invention. In addition, the present invention is not limited by each embodiment, but is limited only by the scope of the claims.

### REFERENCE SIGNS LIST

1 Brittle adhesive sheet
10 Film base material
11 Film base material main body
16 Print receptive layer
10′ Test piece
101 End
102 End
12 Adhesive layer
13 Release liner
14 Label portion
15 Matrix waste portion
20A, 20B Gripping tool

1. A method for producing a label, the method comprising:
a base material main body-forming step of forming a film base material main body formed of a polystyrene-based resin by uniaxial stretching in a machine direction (MD),
an adhesive layer-forming step of forming an adhesive layer at a first surface side of the film base material main body by laminating the adhesive layer and a release liner on the film base material main body,
a print receptive layer-forming step of forming a print receptive layer at a second surface side of the film base material main body,
a die cutting step of forming a label portion and a matrix waste portion by forming a cut line in the film base material and the adhesive layer, and
a matrix removal step of removing the matrix waste portion along the machine direction (MD);
wherein a film base material has the film base material main body and the print receptive layer,
wherein the film base material has a tear strength of 100 mN/mm or more and 1000 mN or less, the tear strength measured in the machine direction (MD) according to JIS K 7128-1:1998, and
wherein the film base material has a tear strength of 1800 mN/mm or more and 3000 mN/mm or less, the tear strength measured in a cross machine direction (CD) at 90° with respect to the machine direction according to JIS K 7128-1:1998.

2. The method for producing the label according to claim 1, wherein the print receptive layer includes a urethane-modified polyester resin.

3. The method for producing the label according to claim 1, wherein the label is transparent.

4. The method for producing the label according to claim 1,
wherein a total light transmittance measured according to JIS K 7361-1:1997 is 80% or more, and/or a haze measured according to JIS K 7136:2000 is 50% or less.

5. The method for producing the label according to claim 1,
wherein the film base material has a tensile elongation at break of 20% or less, the tensile elongation measured in the machine direction (MD) according to JIS Z 0237:2009.

6. The method for producing the label according to claim 1,
wherein the film base material has a tensile strength at break of 100 N/15 mm or less, the tensile strength at break measured in the machine direction (MD) according to JIS Z 0237:2009.

7. The method for producing the label according to claim 1,
wherein the polystyrene-based resin of the film base material main body includes a General Purpose Polystyrene (GPPS) resin and a High-Impact Polysthylene (HIPS) resin.

8. The method for producing the label according to claim 1,
wherein a content of a thermoplastic elastomer is 10 parts by mass or less with respect to 100 parts by mass of the polystyrene-based resin of the film base material main body.

9. The method for producing the label according to claim 1,
wherein the print receptive layer includes an acrylic-based resin.

10. The method for producing the label according to claim 1, wherein the label is used for preventing unauthorized unsealing or preventing tampering.
